(19) United States
(12) Patent Application Publication
(10) Pub. No.: US 2010/0323222 A1
(43) Pub. Date: Dec. 23, 2010

(54) MAGNETIC RECORDING MEDIUM AND METHOD FOR MANUFACTURING THE SAME

(75) Inventors: Eiji Nakashio, Miyagi (JP); Futoshi Sasaki, Miyagi (JP); Katsunori Maeshima, Miyagi (JP); Yusuke Tamakawa, Miyagi (JP); Kuniko Yamamoto, Miyagi (JP); Minoru Yamaga, Miyagi (JP)

Correspondence Address: WOLF GREENFIELD & SACKS, P.C., 600 ATLANTIC AVENUE, BOSTON, MA, 02210-2206, US

(73) Assignee: Sony Corporation, Tokyo (JP)

(21) Appl. No.: 12/815,678

(22) Filed: Jun. 15, 2010

(30) Foreign Application Priority Data
Jun. 23, 2009 (JP) 2009-149208
Apr. 7, 2010 (JP) 2010-089054

(51) Int. Cl. G11B 5/84; G11B 5/00

(52) U.S. Cl. 428/800; 427/131

(57) ABSTRACT

A magnetic recording medium includes: a nonmagnetic support having both principal planes, a nonmagnetic layer formed on one principal plane of the nonmagnetic support and containing a nonmagnetic powder, a conductive particle and a binder, and a magnetic layer formed on the nonmagnetic layer and containing a magnetic powder, a conductive particle and a binder, wherein each of the nonmagnetic layer and the magnetic layer is prepared in a wet on dry mode, and a conduction point particle size of the conductive particle contained in the magnetic layer falls within the range of 3 times or more and not more than 5 times an average thickness of the magnetic layer.

### BACKGROUND OF THE INVENTION

1. Field of the Invention

The present invention relates to a magnetic recording medium and a method for manufacturing the same. In detail, the present invention relates to a magnetic recording medium capable of suppressing an increase of friction.

2. Description of the Related Art

Coating type magnetic recording media in which a magnetic layer is formed by coating a magnetic coating material having a magnetic powder and a binder dispersed therein together with an organic solvent on a nonmagnetic support and drying it have hitherto been known as a magnetic recording medium. Such coating type magnetic recording media are utilized as a recording medium for computer such as a data cartridge for backup and are the mainstream of current magnetic recording media.

In recent years, in magnetic recording media, it is desirable to enhance a recording density. Examples of technologies for enhancing a recording density include reduction of a recording track width, increase of a line recording density and shortening of a recording wavelength.

Such technologies for enhancing the recording density of magnetic recording media are described in JP-A-2004-220754 and JP-A-2004-348844.

### SUMMARY OF THE INVENTION

However, as the high recording density increases, a signal error is easy to occur. For example, in magnetic recording systems of a linear mode, a fixed head is used, and therefore, an unwinding or winding-up rate of a magnetic tape from a spool is fast so that for the purpose of recording all tracks, shuttles in a number obtained by dividing the track number by a recording and reproducing head are necessary. That is, the larger the shuttle number, the larger the unwinding/winding-up number is.

In unwinding/winding-up, since a magnetic recording surface and a magnetic head cause high-speed sliding, smoothness of the magnetic tape surface is enhanced, and a lubricant contained in a coating film is reduced, whereby lubricity is deteriorated. According to this, since friction is generated between the magnetic head and the magnetic tape, the magnetic head sticks to the magnetic tape so that a probability that tape running becomes impossible increases.

As one of effective technologies for suppressing the generation of such a signal error, there is exemplified a reduction of friction on the magnetic recording surface of a magnetic recording medium.

Accordingly, it is desirable to provide a magnetic recording medium which, even when lubricity is deteriorated due to high-speed sliding between a reading means such as a magnetic head and a magnetic recording medium, is able to suppress an increase of a coefficient of friction of the magnetic recording surface and a method for manufacturing the same.

A first embodiment according to the present invention is concerned with a magnetic recording medium including:

a nonmagnetic support having both principal planes,

a nonmagnetic layer formed on one principal plane of the nonmagnetic support and containing a nonmagnetic powder, a conductive particle and a binder, and

a magnetic layer formed on the nonmagnetic layer and containing a magnetic powder, a conductive particle and a binder, wherein

each of the nonmagnetic layer and the magnetic layer is prepared in a wet on dry mode, and

a conduction point particle size of the conductive particle contained in the magnetic layer falls within the range of 3 times or more and not more than 5 times an average thickness of the magnetic layer.

A second embodiment according to the present invention is concerned with a magnetic recording medium including:

a nonmagnetic support having both principal planes,

a nonmagnetic layer formed on one principal plane of the nonmagnetic support and containing a nonmagnetic powder, a conductive particle and a binder, and

a magnetic layer formed on the nonmagnetic layer and containing a magnetic powder, a conductive particle and a binder, wherein

each of the nonmagnetic layer and the magnetic layer is prepared in a wet on wet mode, and

a conduction point particle size of the conductive particle contained in the magnetic layer falls within the range of 1.3 times or more and not more than 3 times an average thickness of the magnetic layer.

A third embodiment according to the present invention is concerned with a method for manufacturing a magnetic recording medium including the steps of:

coating a nonmagnetic layer-forming coating material on a nonmagnetic support and drying it to form a nonmagnetic layer; and

coating a magnetic layer-forming coating material on the nonmagnetic layer and drying it to form a magnetic layer, wherein

a conduction point particle size of a conductive particle of the magnetic layer falls within the range of 3 times or more and not more than 5 times an average thickness of the magnetic layer.

A fourth embodiment according to the present invention is concerned with a method for manufacturing a magnetic recording medium including the steps of:

coating a nonmagnetic layer-forming coating material and a magnetic layer-forming coating material in success on a nonmagnetic support; and

drying the nonmagnetic layer-forming coating material and the magnetic layer-forming coating material each coated on the nonmagnetic support to form a nonmagnetic layer and a magnetic layer, respectively on the nonmagnetic support, wherein

a conduction point particle size of a conductive particle of the magnetic layer falls within the range of 1.3 times or more and not more than 3 times an average thickness of the magnetic layer.

A fifth embodiment according to the present invention is concerned with a magnetic recording medium including:

a nonmagnetic support having both principal planes,

a nonmagnetic layer formed on one principal plane of the nonmagnetic support and containing a nonmagnetic powder, a conductive particle and a binder, and

a magnetic layer formed on the nonmagnetic layer and containing a magnetic powder, a conductive particle and a binder, wherein

each of the nonmagnetic layer and the magnetic layer is prepared in a wet on dry mode,

a conduction point particle size of the conductive particle contained in the magnetic layer is not more than 5 times an average thickness of the magnetic layer, and

the number of conductive particles exposed on one principal plane of the magnetic layer is 14 or more per 100 μm².

A sixth embodiment according to the present invention is concerned with a magnetic recording medium including:

a nonmagnetic support having both principal planes,

a nonmagnetic layer formed on one principal plane of the nonmagnetic support and containing a nonmagnetic powder, a conductive particle and a binder, and

a magnetic layer formed on the nonmagnetic layer and containing a magnetic powder, a conductive particle and a binder, wherein

each of the nonmagnetic layer and the magnetic layer is prepared in a wet on wet mode,

a conduction point particle size of the conductive particle contained in the magnetic layer is not more than 3 times an average thickness of the magnetic layer, and

the number of conductive particles exposed on one principal plane of the magnetic layer is 15 or more per 100 μm².

A seventh embodiment according to the present invention is concerned with a method for manufacturing a magnetic recording medium including the steps of:

coating a nonmagnetic layer-forming coating material on a nonmagnetic support and drying it to form a nonmagnetic layer; and

coating a magnetic layer-forming coating material on the nonmagnetic layer and drying it to form a magnetic layer, wherein

a conduction point particle size of a conductive particle of the magnetic layer is not more than 5 times an average thickness of the magnetic layer, and

the number of conductive particles exposed on one principal plane of the magnetic layer is 14 or more per 100 μm².

An eighth embodiment according to the present invention is concerned with a method for manufacturing a magnetic recording medium including the steps of:

coating a nonmagnetic layer-forming coating material and a magnetic layer-forming coating material in success on a nonmagnetic support; and

drying the nonmagnetic layer-forming coating material and the magnetic layer-forming coating material each coated on the nonmagnetic support to form a nonmagnetic layer and a magnetic layer, respectively on the nonmagnetic support, wherein

a conduction point particle size of a conductive particle of the magnetic layer is not more than 3 times an average thickness of the magnetic layer, and

the number of conductive particles exposed on one principal plane of the magnetic layer is 15 or more per 100 μm².

As described previously, in the first and third embodiments according to the present invention, the nonmagnetic layer-forming coating material is coated on the nonmagnetic support and dried to form the nonmagnetic layer; the magnetic layer-forming coating material is coated on the nonmagnetic layer and dried to form the magnetic layer; and the conduction point particle size of the conductive particle of the magnetic layer is made to fall within the range of 3 times or more and not more than 5 times the average thickness of the magnetic layer. Hence, it is possible to suppress an increase of friction on the magnetic recording surface to be caused due to high-speed sliding between a reading means such as the magnetic head and a magnetic recording medium.

Also, in the second and fourth embodiments according to the present invention, the nonmagnetic layer-forming coating material and the magnetic layer-forming coating material are coated in success on the nonmagnetic support; the nonmagnetic layer-forming coating material and the magnetic layer-forming coating material each coated on the nonmagnetic support are dried to form a nonmagnetic layer and a magnetic layer, respectively on the nonmagnetic support; and the conduction point particle size of the conductive particle of the magnetic layer is made to fall within the range of 1.3 times or more and not more than 3 times the average thickness of the magnetic layer. Hence, it is possible to suppress an increase of friction on the magnetic recording surface to be caused due to high-speed sliding between a reading means such as a magnetic head and the magnetic recording medium.

Also, in the fifth and seventh embodiments according to the present invention, the nonmagnetic layer-forming coating material is coated on the nonmagnetic support and dried to form the nonmagnetic layer; the magnetic layer-forming coating material is coated on the nonmagnetic layer and dried to form the magnetic layer; the conduction point particle size of the conductive particle of the magnetic layer is not more than 5 times the average thickness of the magnetic layer; and the number of conductive particles exposed on one principal plane of the magnetic layer is 14 or more per 100 μm². Hence, it is possible to suppress an increase of friction on the magnetic recording surface to be caused due to high-speed sliding between a reading means such as a magnetic head and the magnetic recording medium.

Also, in the sixth and eighth embodiments according to the present invention, the nonmagnetic layer-forming coating material and the magnetic layer-forming coating material are coated in success on the nonmagnetic support; the nonmagnetic layer-forming coating material and the magnetic layer-forming coating material each coated on the nonmagnetic support are dried to form the nonmagnetic layer and the magnetic layer, respectively on the nonmagnetic support; the conduction point particle size of the conductive particle of the magnetic layer is not more than 3 times the average thickness of the magnetic layer; and the number of conductive particles exposed on one principal plane of the magnetic layer is 15 or more per 100 μm². Hence, it is possible to suppress an increase of friction on the magnetic recording surface to be caused due to high-speed sliding between a reading means such as a magnetic head and the magnetic recording medium.

According to the embodiments of the present invention, the nonmagnetic layer and the magnetic layer are formed on the nonmagnetic support in a wet on dry mode; the conduction point particle size of the conductive particle of the magnetic layer is made to fall within the range of 3 times or more and not more than 5 times the average thickness of the magnetic layer; and the number of conductive particles exposed on one principal plane of the magnetic layer is 14 or more per 100 μm². Thus, there is brought an effect for suppressing an increase of friction on the magnetic recording surface of the magnetic recording medium.

Also, according to the embodiments of the present invention, the nonmagnetic layer and the magnetic layer are formed on the nonmagnetic support in a wet on wet mode; the conduction point particle size of the conductive particle of the magnetic layer falls within the range of 1.3 times or more and not more than 3 times the average thickness of the magnetic layer; and the number of conductive particles exposed on one principal plane of the magnetic layer is 15 or more per 100 μm². Thus, there is brought an effect for suppressing an increase of friction on the magnetic recording surface of the magnetic recording medium.

### BRIEF DESCRIPTION OF THE DRAWINGS

FIG. 1 shows a diagrammatic sectional view of an example of a magnetic recording medium according to an embodiment of the present invention.

FIGS. 2A and 2B are a diagrammatic sectional view showing a configuration of a magnetic recording medium formed in a wet on dry mode and a wet on wet mode, respectively.

FIG. 3 is an outlined line drawing showing a particle size distribution of spherical silica.

FIG. 4A is a diagrammatic sectional view showing a configuration of a magnetic recording medium formed in a wet on dry mode using carbon black as a conductive particle; and FIG. 4B is a diagrammatic sectional view showing a configuration of a magnetic recording medium formed in a wet on wet mode using carbon black as a conductive particle.

FIG. 5A is a diagrammatic sectional view showing a configuration of a magnetic recording medium formed in a wet on dry mode using hybrid black as a conductive particle; and FIG. 5B is a diagrammatic sectional view showing a configuration of a magnetic recording medium formed in a wet on wet mode using hybrid black as a conductive particle.

FIG. 6 is a flowchart showing an example of a flow of manufacturing steps of a magnetic recording medium adopting a wet on dry coating mode.

FIG. 7 is an outlined line drawing showing a particle size distribution of carbon black.

FIGS. 8A and 8B are an outlined line drawing showing conduction points on a magnetic layer surface in Examples 1 and 2, respectively.

FIGS. 9A and 9B are an outlined line drawing showing a relation between a carbon particle distribution and an average conduction point density in Examples 1 and 2, respectively.

FIG. 10 is an outlined line drawing for explaining a relation between the number of conduction points and friction.

FIG. 11 is an outline line drawing for explaining a relation between the number of conduction points and a reproduced output in each of Examples 9-1 to 9-4 and Comparative Example 7-1.

FIGS. 12A and 12B are each an outlined line drawing for explaining a relation between a minimum conduction point particle size and an error rate in Example 10.

FIGS. 13A and 13B are each an outlined line drawing for explaining a relation between a minimum conduction point particle size and an error rate in Example 11.

FIGS. 14A and 14B are each an outlined line drawing for explaining a relation between a minimum conduction point particle size and an error rate in Comparative Example 8.

FIGS. 15A and 15B are each an outlined line drawing for explaining a relation between a minimum conduction point particle size and an error rate in Comparative Example 9.

FIGS. 16A and 16B are each an outlined line drawing for explaining a relation between a minimum conduction point particle size and an error rate in Example 12.

FIGS. 17A and 17B are each an outlined line drawing for explaining a relation between a minimum conduction point particle size and an error rate in Example 13.

FIGS. 18A and 18B are each an outlined line drawing for explaining a relation between a minimum conduction point particle size and an error rate in Comparative Example 10.

FIG. 19A is an outlined line drawing for explaining a relation between a volume proportion of silica and friction in each of Examples 14-1 to 14-3; and FIG. 19B is an outlined line drawing for explaining a relation between a volume proportion of silica and friction in each of Examples 15-1 to 15-3.

FIG. 20A is an outlined line drawing for explaining a relation between a particle size of silica and friction in each of Examples 16-1 to 16-2 and Comparative Examples 11-1 to 11-3; and FIG. 20B is an outlined line drawing for explaining a relation between a particle size of silica and friction in each of Examples 17-1 to 17-2 and Comparative Examples 12-1 to 12-3.

FIG. 21A is an outlined line drawing for explaining a relation between a volume proportion of silica and an error rate in each of Examples 14-1 to 14-3; and FIG. 21B is an outlined line drawing for explaining a relation between a volume proportion of silica and an error rate in each of Examples 15-1 to 15-3.

FIG. 22A is an outline line drawing for explaining a relation between a particle size of silica and an error rate in each of Examples 16-1 to 16-2 and Comparative Examples 11-1 to 11-3; and FIG. 22B is an outline line drawing for explaining a relation between a particle size of silica and an error rate in each of Examples 17-1 to 17-2 and Comparative Examples 12-1 to 12-3.

### DESCRIPTION OF THE PREFERRED EMBODIMENTS

### Configuration of Magnetic Recording Medium

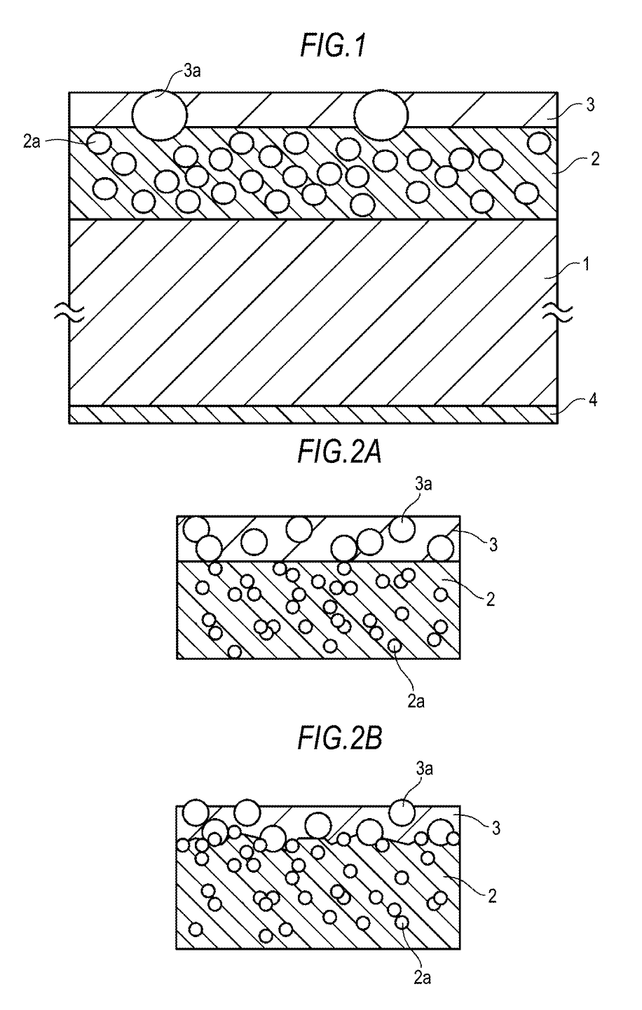

An embodiment according to the present invention is described by reference to the accompanying drawings. FIG. 1 is a diagrammatic sectional view of an example of a magnetic recording medium according to the embodiment of the present invention. The magnetic recording medium includes a longitudinal nonmagnetic support 1, a nonmagnetic layer 2 formed on one principal plane of the longitudinal nonmagnetic support 1 and a magnetic layer 3 formed on the nonmagnetic layer 2. If desired, the magnetic recording medium may further include a backcoat layer 4 formed on the other principal plane of the longitudinal nonmagnetic support 1. An interface between the nonmagnetic layer 2 and the magnetic layer 3 varies depending upon a difference of a coating mode. This magnetic recording medium according to the embodiment of the present invention is suitable for use in a recording and reproducing system to which a linear mode is applied.

FIG. 2A is a diagrammatic sectional view showing a configuration of a magnetic recording medium formed in a wet on dry mode (coating and drying step). FIG. 2B is a diagrammatic sectional view showing a configuration of a magnetic recording medium formed in a wet on wet mode (wet multi-layer coating mode). As shown in FIG. 2A, the interface between the nonmagnetic layer 2 and the magnetic layer 3 formed in a wet on dry mode is distinct. On the contrary, as shown in FIG. 2B, the interface between the nonmagnetic layer 2 and the magnetic layer 3 formed in a wet on wet mode is indistinct.

### (Nonmagnetic Support)

The nonmagnetic support 1 is described. Examples of a material of the nonmagnetic support 1 include polyesters such as polyethylene terephthalate; polyolefins such as polyethylene and polypropylene; cellulose derivatives such as cellulose triacetate, cellulose diacetate and cellulose butyrate; vinyl based resins such as polyvinyl chloride and polyvinylidene chloride; plastics such as polycarbonate, polyimide and polyamide-imide; light metals such as aluminum alloys and titanium alloys; and ceramics such as alumina glass. Furthermore, for the purpose of increasing a mechanical strength, a material obtained by depositing a thin film including an oxide of Al or Cu, such as an aluminum oxide film, on at least one of the principal planes of the nonmagnetic support 1 including a vinyl based resin or the like is also exemplified as the material of the nonmagnetic support 1. Examples of the deposition method which can be adopted include a vapor deposition method, a chemical vapor deposition method and a sputtering method.

### (Magnetic Layer)

Next, the magnetic layer 3 is described. The magnetic layer 3 is composed mainly of a magnetic powder, a binder and a conductive particle 3a, and it is formed by further mixing additives such as a lubricant, a polishing agent and a rust preventive, kneading and dispersing the mixture using an organic solvent and coating the thus prepared magnetic coating material.

An average thickness of the magnetic layer 3 is preferably 50 nm or more and not more than 75 nm, more preferably 50 nm or more and not more than 70 nm, and further preferably 50 nm or more and not more than 65 nm. When the average thickness of the magnetic layer 3 is 50 nm or more, the magnetic layer 3 having a fixed thickness can be formed. On the other hand, when the average thickness of the magnetic layer 3 is not more than 75 nm, a recording density can be enhanced.

### (Magnetic Powder)

As the magnetic powder, one having magnetic characteristics (for example, coercive force and magnetizing force) which are suitable for recording and reproducing characteristics of a VTR format or a data drive format to be applied is chosen. Examples thereof include Fe based and Fe—Co based metal powders, barium ferrite, iron carbide and iron oxide. A metal compound of, as a sub-element, Co, Ni, Cr, Mn, Mg, Ca, Ba, Sr, Zn, Ti, Mo, Ag, Cu, Na, K, Li, Al, Si, Ge, Ga, Y, Nd, La, Ce, Zr or the like may coexist.

### (Binder)

As a binder constituting the magnetic layer 3 of the magnetic recording medium according to the embodiment of the present invention, resins having a structure in which a crosslinking reaction is imparted to a polyurethane based resin, a vinyl chloride based resin or the like are preferable. However, the binder is not limited thereto, and known other resins may be properly blended depending upon physical properties required for the desired magnetic recording medium. The resin which is blended is not particularly limited so far as it is a resin which is usually used for magnetic recording media of a coating type.

Examples thereof include a polyvinyl chloride based resin, a polyvinyl acetate based resin, a vinyl chloride-vinyl acetate copolymer, a vinyl chloride-vinylidene chloride copolymer, a vinyl chloride-acrylonitrile copolymer, an acrylic ester-acrylonitrile copolymer, an acrylic ester-vinyl chloride-vinylidene chloride copolymer, a vinyl chloride-acrylonitrile copolymer, an acrylic ester-acrylonitrile copolymer, an acrylic ester-vinylidene chloride copolymer, a methacrylic ester-vinylidene chloride copolymer, a methacrylic ester-vinyl chloride copolymer, a methacrylic ester-ethylene copolymer, polyvinyl fluoride, a vinylidene chloride-acrylonitrile copolymer, an acrylonitrile-butadiene copolymer, a polyamide resin, polyvinyl butyral, a cellulose derivative (for example, cellulose acetate butyrate, cellulose diacetate, cellulose triacetate, cellulose propionate and nitrocellulose), a styrene-butadiene copolymer, a polyester resin, an amino resin and a synthetic rubber.

Also, examples of a thermosetting resin or a reaction type resin include a phenol resin, an epoxy resin, a urea resin, a melamine resin, an alkyd resin, a silicone resin, a polyamine resin and a urea-formaldehyde resin.

Also, for the purpose of enhancing dispersibility of the magnetic powder, a polar functional group such as —SO₃M, —OSO₃M, —COOM and P═O(OM)₂ may be introduced into each of the foregoing binders. Here, M represents a hydrogen atom or an alkali metal such as lithium, potassium and sodium.

Furthermore, examples of the polar functional group include a side chain type having a terminal group of —NR1R2 or —NR1R2R3⁺X⁻ and a principal chain type of >NR1R2⁺X⁻. Here, in the formulae, each of R1, R2 and R3 represents a hydrogen atom or a hydrocarbon group; and X⁻ represents a halogen element ion of fluorine, chlorine, bromine, iodine or the like or an inorganic or organic ion. Also, other examples of the polar functional group include —OH, —SH, —CN and an epoxy group.

### (Conductive Particle)

As the conductive particle 3a, fine particles composed mainly of carbon, for example, carbon black can be used. As the carbon black, for example, ASAHI #15 and #15HS of Asahi Carbon Co., Ltd. and the like can be used.

Here, when a large amount of nonmagnetic carbon black is incorporated into the magnetic layer 3, a reproduced output is lowered. Also, in the case of using carbon black having a large particle size (diameter), the particle becomes a projection on the surface of the magnetic recording medium and forms a gap (hereinafter properly referred to as “spacing”) between a magnetic head and the magnetic recording medium, thereby deteriorating the reproduced output and reproduction resolution. For that reason, in an embodiment according to the present invention, the conductive particle 3a in which the particle size is a prescribed size relative to the thickness of the magnetic layer 3 is incorporated so that an appropriate spacing is produced between the magnetic head and the magnetic recording medium.

In the case of preparing the magnetic recording medium in a wet on dry mode, it is preferable that a conduction point particle size (diameter) of the conductive particle 3a falls within the range of 3 times or more and not more than 5 times the average thickness of the magnetic layer 3. When the conduction point particle size of the conductive particle 3a is less than 3 times, there is a tendency that it is difficult to form a conduction point by the conductive particle 3a. On the other hand, when it exceeds 5 times, there is a tendency that the conductive particle 3a is projected from the surface of the medium to produce a spacing.

Also, in the case of preparing the magnetic recording medium in a wet on dry mode, it is preferable that a minimum conduction point particle size (diameter) of the conductive particle 3a falls within the range of 3 times or more and not more than 5 times the average thickness of the magnetic layer 3. When the minimum conduction point particle size of the conductive particle 3a is less than 3 times, there is a tendency that it is difficult to form a conduction point by the conductive particle 3a. On the other hand, when it exceeds 5 times, the spacing between the magnetic head and the magnetic recording medium becomes too large, and therefore, there is a tendency to cause a lowering of recording and reproducing characteristics such as a lowering of a reproduced output and deterioration of an error rate. In the case of preparing the magnetic recording medium in a wet on dry mode, a particle size of the conductive particle 3a is preferably 150 nm or more and not more than 375 nm, more preferably 150 nm or more and not more than 250 nm, and further preferably 150 nm or more and not more than 200 nm; and an average thickness of the magnetic layer 3 is preferably 50 nm or more and not more than 75 nm, more preferably 50 nm or more and not more than 70 nm, and further preferably 50 nm or more and not more than 65 nm.

Also, in the case of preparing the magnetic recording medium in a wet on dry mode, the number of the conductive particles 3a exposed on one principal plane of the magnetic layer 3 is 14 or more per 100 μm², and more preferably 14 or more and not more than 70 per 100 μm². When the number of the conductive particles 3a exposed on one principal plane of the magnetic layer 3 is 14 or more per 100 μm², not only an increase of friction following an increase of the running number can be suppressed, but the friction can be decreased. When it is not more than 70 per 100 μm², lowering of the reproduced output can be suppressed.

In the case of preparing the magnetic recording medium in a wet on wet mode, it is preferable that a conduction point particle size (diameter) of the conductive particle 3a falls within the range of 1.3 times or more and not more than 3 times the average thickness of the magnetic layer 3. When the conduction point particle size of the conductive particle 3a is less than 1.3 times, there is a tendency that it is difficult to form a conduction point by the conductive particle 3a. On the other hand, when it exceeds 3 times, there is a tendency that the conductive particle 3a is projected from the medium surface to produce a spacing.

Also, in the case of preparing the magnetic recording medium in a wet on wet mode, it is preferable that a minimum conduction point particle size (diameter) of the conductive particle 3a falls within the range of 1.3 times or more and not more than 3 times the average thickness of the magnetic layer 3. When the minimum conduction point particle size of the conductive particle 3a is less than 1.3 times, there is a tendency that it is difficult to form a conduction point by the conductive particle 3a. On the other hand, when it exceeds 3 times, the spacing between the magnetic head and the magnetic recording medium becomes too large, and therefore, there is a tendency to cause a lowering of recording and reproducing characteristics such as a lowering of a reproduced output and deterioration of an error rate. In that case, a particle size of the conductive particle 3a is preferably 65 nm or more and not more than 225 nm, more preferably 65 nm or more and not more than 165 nm, and further preferably 65 nm or more and not more than 115 nm.

Also, in the case of preparing the magnetic recording medium in a wet on wet mode, the number of the conductive particles 3a exposed on one principal plane of the magnetic layer 3 is 15 or more per 100 μm², and more preferably 15 or more and not more than 70 per 100 μm². When the number of the conductive particles 3a exposed on one principal plane of the magnetic layer 3 is 15 or more per 100 μm², not only an increase of friction following an increase of the running number can be suppressed, but the friction can be decreased. When it is not more than 70 per 100 μm², the lowering of the reproduced output can be suppressed.

In this way, when the magnetic layer 3 contains the conductive particle 3a having a minimum conduction point particle size larger than the known one, the number of the conductive particles 3a which do not contribute to the conduction point can be decreased, and a nonmagnetic component in the magnetic layer can be reduced. Therefore, the reproduced output can be enhanced.

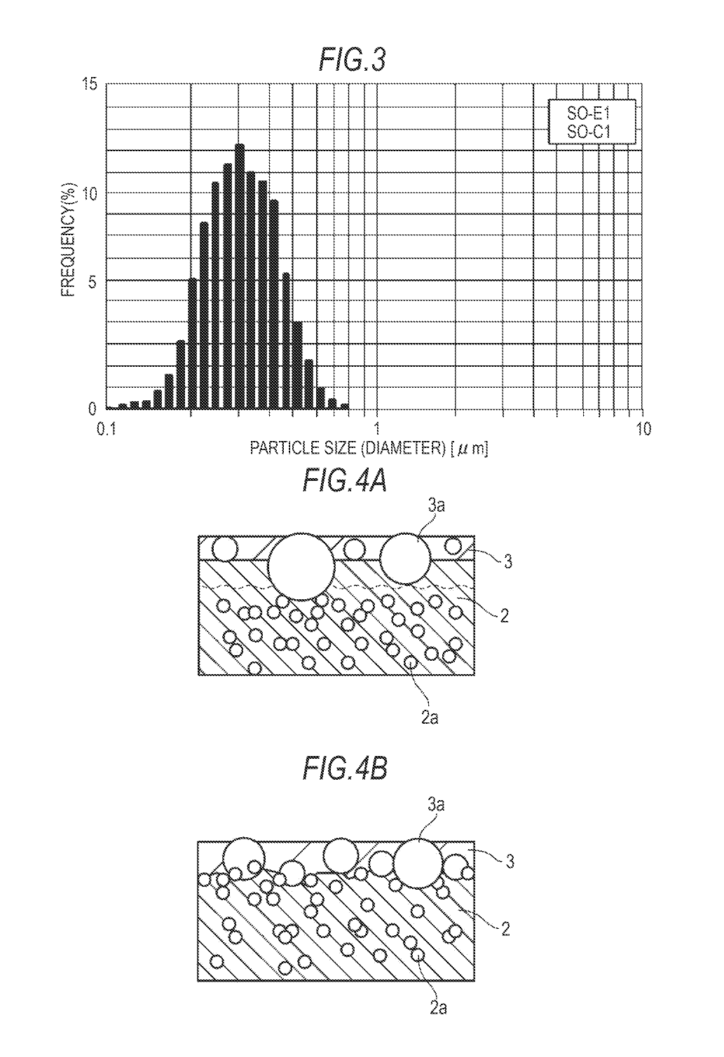

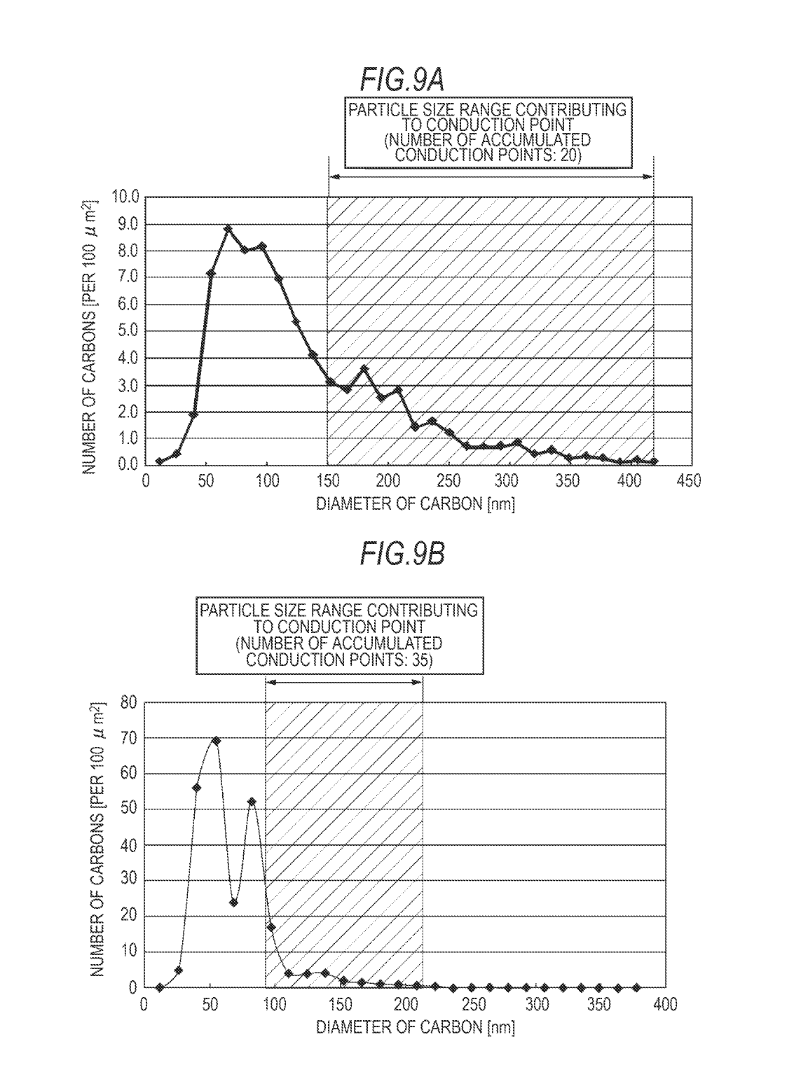

As shown in FIGS. 9A and 9B as described later, in the case of using a carbon particle (carbon black) as the conductive particle 3a, a proportion of the carbon particle which does not contribute to the conduction point increases. The ideal conductive particle 3a does not have a particle size distribution at all and preferably has a particle size of about 3 times in a wet on dry mode and about 1.3 times in a wet on wet mode, respectively. As the conductive particle 3a which meets such a requirement, hybrid carbon in which carbon is attached to the surface of a silica particle with a small particle size dispersion is suitable. A particle size distribution of spherical silica serving as a material of the hybrid carbon is shown in FIG. 3. Specifically, this particle size distribution is one of ADMAFINE (Model No.: SO-E1), manufactured by Admatechs Company Limited. As shown in FIG. 3, the particle size distribution of the spherical silica is very small as compared with that of carbon black. By using the conductive particle having such a particle size distribution, it is possible to increase the proportion of particle capable of becoming a practically effective conduction point. As the conductive particle which is attached to the surface of the silica particle, for example, neutral carbon black, specifically carbon black having a particle size of about 15 nm can be used. As such carbon black, for example, SUNBLACK S905, manufactured by Asahi Carbon Co., Ltd. or the like can be used. Such carbon black is adsorbed on the silica surface. On that occasion, in the case where the silica volume is 100 nm, it is preferable that the carbon black is uniformly adsorbed in an amount of 40% in terms of a volume proportion; and in the case where the silica volume is 200 nm, it is preferable that the carbon black is adsorbed in an amount of about 18% in terms of a volume proportion. When hybrid carbon with a small particle size dispersion is used, the proportion of the particle which does not contribute to the conductivity can be decreased, and a nonmagnetic component in the magnetic film can be reduced. Therefore, the reproduced output can be enhanced. Here, though the silica particle is used, it is also possible to use a ceramic particle or a conductive metal particle of Au, Ag or the like as the conductive particle 3a as it is in place of the silica particle.

### (Lubricant)

As a lubricant which is incorporated into the magnetic layer 3 and the nonmagnetic layer 2, for example, esters of a monobasic fatty acid having from 10 to 24 carbon atoms and any one of monohydric to hexahydric alcohols having from 2 to 12 carbon atoms and mixed esters thereof, di-fatty acid esters and tri-fatty acid esters can be properly used. Specific examples of the lubricant include lauric acid, myristic acid, palmitic acid, stearic acid, behenic acid, oleic acid, linolic acid, linoleic acid, elaidic acid, butyl stearate, pentyl stearate, heptyl stearate, octyl stearate, isooctyl stearate and octyl myristate.

### (Nonmagnetic Reinforcing Particle)

The magnetic layer 3 may contain, as a nonmagnetic reinforcing particle, aluminum oxide (for example, α-, β- or γ-aluminum oxide), chromium oxide, silicon oxide, diamond, garnet, emery, born nitride, titanium carbide, silicon carbide, titanium carbide, titanium oxide (for example, rutile or anatase) or the like.

### (Nonmagnetic Layer)

Next, the nonmagnetic layer 2 is described. The nonmagnetic layer 2 is composed mainly of a nonmagnetic powder and a binder, and it is formed by further a conductive particle 2a and mixing various additives such as a lubricant, kneading and dispersing the mixture using an organic solvent and coating the thus prepared coating material for nonmagnetic layer as a lower layer.

### (Nonmagnetic Powder)

As the nonmagnetic powder, fine particles having various shapes such as an acicular shape, a spherical shape and a platy shape can be properly used.

### (Binder)

As a binder constituting the nonmagnetic layer 2, all of those which can be applied in the foregoing magnetic layer 3 can be used. Also, in the nonmagnetic layer 2, a polyisocyanate may be used jointly with the resin and crosslinked and cured. Examples of the polyisocyanate include toluene diisocyanate and adducts thereof; and an alkylene diisocyanate and adducts thereof.

### (Conductive Particle)

Similar to the foregoing conductive particle 3a of the magnetic layer 3, for example, carbon black or the foregoing hybrid carbon can be used as the conductive particle 2a of the nonmagnetic layer 2. Since the nonmagnetic layer 2 is nonmagnetic, it does not affect a reading output of the magnetic recording medium. Thus, a large amount of carbon black can be mixed. Specifically, for example, by mixing a large amount of carbon black having an average particle size of about 30 nm, an electric resistance on the side of the magnetic layer-forming surface of the magnetic recording medium can be relatively easily lowered to about 2×10⁵ Ω/cm². When the electric resistance exceeds 2×10⁵ Ω/cm², electric charges are easy to accumulate so that friction to be caused when a magnetic head and a magnetic tape come into contact with each other increases, whereby sticking of the magnetic tape to the magnetic head is easy to occur. Here, the electric resistance value is a value measured in the following manner. The side of the magnetic recording layer of the magnetic recording medium is brought into contact with a pair of parallel electrodes in which a distance between the electrodes is 25.4 mm, and a load of 80 gf is applied to the both ends of the magnetic recording medium. Then, a voltage of DC 100 V is impressed between the electrodes in this state, a resistance value is measured by a high resistance meter, and the obtained resistance value is divided by an area of the magnetic recording medium between the electrodes.

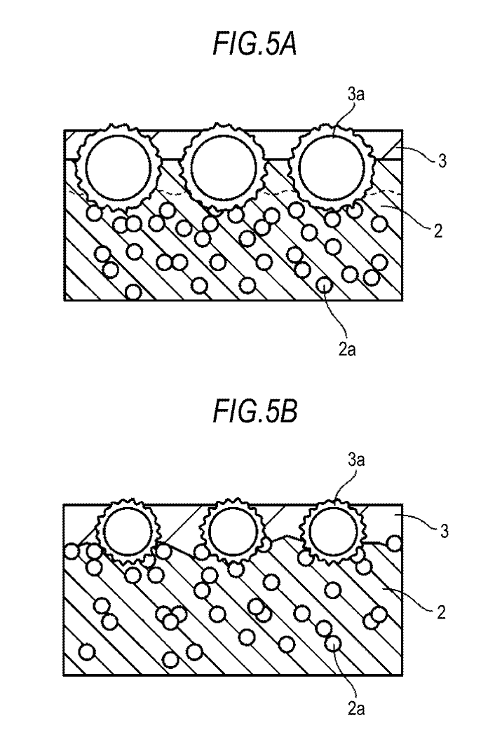

A relation between the minimum conduction point particle size of the conductive particle 3a and the average thickness of the magnetic layer 3 is described in more detail by reference to FIGS. 4A and 4B and FIGS. 5A and 5B. FIG. 4A is a diagrammatic sectional view showing a configuration of a magnetic recording medium formed in a wet on dry mode using carbon black as the conductive particle 3a; and FIG. 4B is a diagrammatic sectional view showing a configuration of a magnetic recording medium formed in a wet on wet mode using carbon black as the conductive particle 3a. FIG. 5A is a diagrammatic sectional view showing a configuration of a magnetic recording medium formed in a wet on dry mode using hybrid black as the conductive particle 3a; and FIG. 5B is a diagrammatic sectional view showing a configuration of a magnetic recording medium formed in a wet on wet mode using hybrid black as the conductive particle 3a.

As described previously, in the case of preparing the magnetic recording medium in a wet on wet mode, it is preferable that a minimum conduction point particle size (diameter) of the conductive particle 3a falls within the range of 1.3 times or more the average thickness of the magnetic layer 3. The reason why the magnetic layer 3 is required to contain the conductive particle 3a having a large minimum conduction point particle size relative to the average thickness of the magnetic layer 3 is as follows. In order that the conductive particle 3a may form a conduction point, the conductive particle 3a is required to function as an electrical path between the surface of the magnetic layer 3 and the nonmagnetic layer 2. For that reason, as shown in FIGS. 4A and 5A, it is necessary that not only a part of the conductive particles 3a is projected from the surface of the magnetic layer 3, but a part of the conductive particles 3a is projected from the magnetic layer 3 toward the nonmagnetic layer 2, and this projected part is electrically connected to the conductive particle 2a contained in the nonmagnetic layer 2. It may be considered that when the minimum conduction point particle size (diameter) of the conductive particle 3a is 1.3 times or more the average thickness of the magnetic layer 3, the conductive particle 2a can secure such a state.

Also, as described previously, in the case of preparing the magnetic recording medium in a wet on dry mode, it is preferable that a minimum conduction point particle size (diameter) of the conductive particle 3a is 3 times or more the average thickness of the magnetic layer 3. It may be considered that the reason why the magnetic layer 3 is required to contain the conductive particle 3a having a larger minimum conduction point particle size relative to the average thickness of the magnetic layer 3 than that in the case of the foregoing wet on wet mode is as follows. As shown in FIGS. 4A and 5A, it may be considered that in the case of forming the nonmagnetic layer 2 and the magnetic layer 3 in a wet on dry mode, in the nonmagnetic layer 2, a region where the conductive particle 2a is alienated is formed in the vicinity of an interface with the magnetic layer 3. It may be considered that when the minimum conduction point particle size (diameter) of the conductive particle 3a is 3 times or more the average thickness of the magnetic layer 3, by projecting a part of the conductive particles 3a from the foregoing region where the conductive particle 2a is alienated, this projected part can be electrically connected to the conductive particle 2a contained in the nonmagnetic layer 2.

### [Manufacturing Method of Magnetic Recording Medium]

Next, an example of a method for manufacturing a magnetic recording medium having the foregoing configuration is described. First of all, a nonmagnetic powder, the conductive particle 2a and a binder are kneaded and dispersed in a solvent to prepare a nonmagnetic layer-forming coating material. Subsequently, a magnetic powder, the conductive particle 3a and a binder are kneaded and dispersed in a solvent to prepare a magnetic layer-forming coating material. In preparing the magnetic layer-forming coating material and the nonmagnetic layer-forming coating material, the same solvent, dispersion apparatus and kneading apparatus can be applied.

Examples of the solvent which is used for preparing each of the foregoing coating materials include ketone based solvents such as acetone, methyl ethyl ketone, methyl isobutyl ketone and cyclohexanone; alcohol based solvents such as methanol, ethanol and propanol; ester based solvents such as methyl acetate, ethyl acetate, butyl acetate, propyl acetate, ethyl lactate and ethylene glycol acetate; ether based solvents such as diethylene glycol dimethyl ether, 2-ethoxyethanol, tetrahydrofuran and dioxane; aromatic hydrocarbon based solvents such as benzene, toluene and xylene; and halogenated hydrocarbon based solvents such as methylene chloride, ethylene chloride, carbon tetrachloride, chloroform and chlorobenzene. These solvents may be used alone, or may be properly mixed and used.

As the kneading apparatus which is used for preparing each of the foregoing coating materials, known kneading apparatuses, for example, a continuous twin-screw kneader, a continuous twin-screw kneader capable of achieving dilution in multiple stages, a kneader, a pressure kneader, a roll kneader, etc. can be used, but it should not be construed that the kneading apparatus is limited to these apparatuses. Also, as the dispersion apparatus which is used for preparing each of the foregoing coating materials, known dispersion apparatuses, for example, a roll mill, a ball mill, a lateral sand mill, a vertical sand mill, a spike mill, a pin mill, a tower mill, DCP, a homogenizer, an ultrasonic dispersion machine, etc. can be used, but it should not be construed that the dispersion apparatus is limited to these apparatuses.

Subsequently, the thus prepared magnetic layer-forming coating material and nonmagnetic layer-forming coating material are subjected to multi-layer coating on the nonmagnetic support 1 and then subjected to a drying treatment, thereby forming the magnetic layer 3 and the nonmagnetic layer 2 on the nonmagnetic support 1. As a method for coating the coating material, for example, any method of a wet on dry coating mode (coating and drying step) or a wet on wet coating mode (wet multi-layer coating mode) can be adopted.

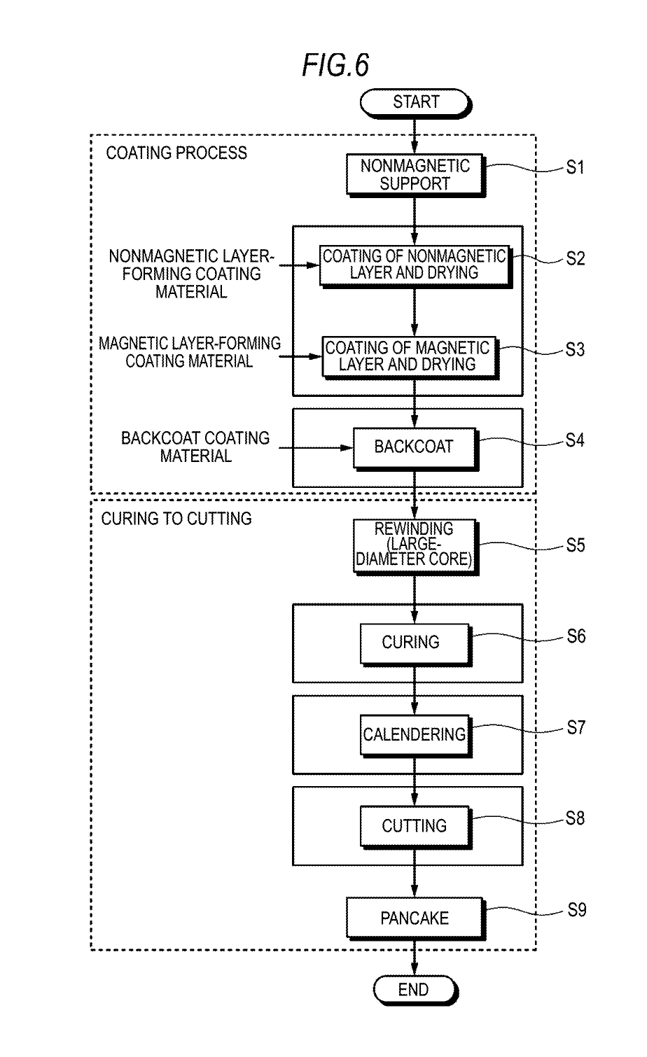

Next, the manufacturing steps of a magnetic recording medium adopting a wet on dry mode of these two modes are described by reference to a flowchart shown in FIG. 6. In the wet on dry coating mode, the nonmagnetic support 1 is prepared (Step S1); and a nonmagnetic layer-forming coating material is coated on one principal plane of the nonmagnetic support 1 and dried to form the nonmagnetic layer 2 (Step S2). Subsequently, a magnetic layer-forming coating material is coated on this nonmagnetic layer 2 and dried to form the magnetic layer 3 on the nonmagnetic layer 2 (Step S3). Subsequently, in Step S4, a backcoat layer-forming coating material is coated on the other principal plane of the nonmagnetic support 1 and dried to form the backcoat 4.

Subsequently, the nonmagnetic support 1 having the nonmagnetic layer 2, the magnetic layer 3 and the backcoat layer 4 formed thereon is rewound around a large-diameter core in Step S5 and then subjected to a curing treatment (Step S6). The nonmagnetic support 1 having the nonmagnetic layer 2, the magnetic layer 3 and the backcoat layer 4 formed thereon is subjected to a calendering treatment in Step S7 and then cut into a prescribed width in Step S8. There can be thus obtained a pancake cut into a prescribed width in Step S9.

The step of forming the backcoat layer 4 in the Step S4 may be carried out after the calendering treatment in the Step S7.

In the wet on wet coating mode (wet multi-layer coating mode), in place of the foregoing Step S2 and Step S3, a nonmagnetic layer-forming coating material is coated on one principal plane of the nonmagnetic support 1 to form a coating film; a magnetic layer-forming coating material is superimposed and coated on this coating film in a wet state to form a coating film; and the both coating films are then dried, whereby a magnetic recording medium can be manufactured.

In this embodiment according to the present invention, as described previously, in the case of preparing the magnetic recording medium in a wet on dry mode, it is preferable that the particle size of the conductive particle 3a within the magnetic layer 3 falls within the range of 3 times or more and not more than 5 times the thickness of the magnetic layer 3.

In the case where the particle size of the conductive particle 3a exceeds 5 times the thickness of the magnetic layer 3, a contact area between the magnetic head and the magnetic recording medium is reduced so that friction can be suppressed. However, in that case, the projection on the surface of the magnetic layer 3 due to the conductive particle 3a produces a spacing between the magnetic recording medium and the magnetic head, thereby lowering the regenerated output.

On the other hand, in the case where the particle size of the conductive particle 3a is less than 3 times the thickness of the magnetic layer 3, the reproduced output can be enhanced while making the spacing low. However, in that case, the conductive particle 3a within the magnetic layer 3 is not exposed on the surface of the magnetic layer 3. Also, since the binder is deposited between the nonmagnetic layer 2 and the magnetic layer 3, the electrical contact between the nonmagnetic layer 2 and the conductive particle 3a within the magnetic layer 3 cannot be kept so that electrostatic breakage occurs.

Also, as described previously, in the case of preparing the magnetic recording medium in a wet on wet mode, it is preferable that the particle size of the conductive particle 3a within the magnetic layer 3 falls within the range of 1.3 times or more and not more than 3 times the thickness of the magnetic layer 3.

In this way, in this embodiment according to the present invention, by appropriately choosing the particle size of the conductive particle 3a depending upon the thickness of the magnetic layer 3 to make a height of the projection due to the conductive particle 3a exposed on the surface of the magnetic layer 3 appropriate, not only an increase of friction on a magnetic recording surface to be caused due to high-speed sliding between the magnetic head and the magnetic recording medium can be suppressed, but the reproduced output can be increased.

Also, in order to reproduce the magnetic recording medium having been recorded in a high density, it is necessary to employ a high sensitivity magnetic head, for example, a magnetic head using a giant magneto resistive effect. On the other hand, in the case of using such a magnetic head, electrostatic breakage of a giant magneto resistive effect device may be considered.

In the existent linear mode, the foregoing sticking of the magnetic head and electrostatic breakage of the magnetic head are significantly problematic. However, according to this embodiment of the present invention, by appropriately choosing the particle size of the conductive particle 3a depending upon the thickness of the magnetic layer 3, electrical contact between the nonmagnetic layer 2 and the conductive particle 3a within the magnetic layer 3 can be kept. According to this, a resistance value of the magnetic recording medium can be lowered, and therefore, an electrical discharge effect is superior to an electrical charge effect due to the friction between the magnetic recording surface of the magnetic recording medium and the magnetic head, and electrification is suppressed, whereby electrostatic breakage of the magnetic head can be reduced.

With respect to the fact that the particle size of the conductive particle 3a in the case of adopting a wet on dry mode is larger than that in the case adopting a wet on wet mode, it may be supposed that as described previously, a region where the conductive particle 2a is alienated is formed in the vicinity of an interface of the nonmagnetic layer 2 with the magnetic layer 3, whereby electrical contact between the nonmagnetic layer 2 and the magnetic layer is kept.

### EXAMPLES

The present invention is specifically described below with reference to the following Examples, but it should not be construed that the present invention is limited only to these Examples.

The Examples of the present invention are described in the following order by reference to the accompanying drawings.

1. Measurement methods of respective physical properties in the Examples

2. Review on minimum conduction point particle size

3. Review on relation between the number of conduction points and friction

4. Review on relation between minimum conduction point particle size and reproduced output

5. Review on relation between minimum conduction point particle size and error rate

6. Review on the case of using hybrid carbon

### 1. Measurement Methods of Respective Physical Properties in the Examples

In the Examples, a particle size distribution and an average particle size of the conductive particle 3a and an average thickness of the magnetic layer 3 were measured in the following manners.

### (Particle Size Distribution and Average Particle Size)

A particle size distribution and an average particle size of the conductive particle 3a were determined in the following manner. First of all, carbon black serving as the conductive particle 3a was formed into an aqueous solution and dispersed by a homogenizer. Subsequently, a sample was collected on a sample stage (ordinary name: mesh) for a transmission electron microscope (hereinafter referred to as “TEM”). Subsequently, the sample was set in TEM and observed with a magnification of 60,000 times. On that occasion, an accelerating voltage was set up at 200 V. Subsequently, the particle size of 300 or more particles was arbitrarily measured from several tens sheets of image files, and a statistical treatment was performed from the measurement results, thereby determining a particle size distribution and an average particle size.

### (Average Thickness of Nonmagnetic Layer and Magnetic Layer)

An average thickness of each of the nonmagnetic layer 2 and the magnetic layer 3 was determined in the following manner. First of all, a magnetic tape was cut out vertical against its principal plane, and a cross section thereof was photographed by TEM with a magnification of 60,000 times. Subsequently, 10 points were chosen at random from the photographed TEM photograph, and the thickness of each of the nonmagnetic layer and the magnetic layer was measured in those respective points. Subsequently, these measured values were simply averaged (arithmetically averaged), thereby determining an average thickness of each of the nonmagnetic layer 2 and the magnetic layer 3.

### 2. Review on Minimum Conduction Point Particle Size

### Example 1

A first composition having the following blending was kneaded by an extruder. Thereafter, the first composition and a second composition having the following blending were added in a stirring tank equipped with a disper and preliminarily mixed. Thereafter, the mixture was further mixed by a sand mill and subjected to a filtration treatment, thereby preparing a magnetic layer-forming coating material.

### (First Composition)

Fe—Co based metal magnetic powder A (major axis length: 0.1 μm, Co/Fe=30 atm %, specific surface area=47 m²/g, saturation magnetization=150 Am²/kg, coercive force=184 kA/m): 100 parts by weight

Vinyl chloride based resin A (cyclohexanone solution: 30 wt %) (polymerization degree: 300, Mn=10,000; containing 0.07 mmoles/g of OSO₃K and 0.3 mmoles/g of secondary OH as polar groups): 55.6 parts by weight

Aluminum oxide powder A (α-Al₂O₃, average particle size: 0.2 μm): 5 parts by weight

Carbon black (a trade name: SEAST TA, manufactured by Tokai Carbon Co., Ltd.): 2 parts by weight

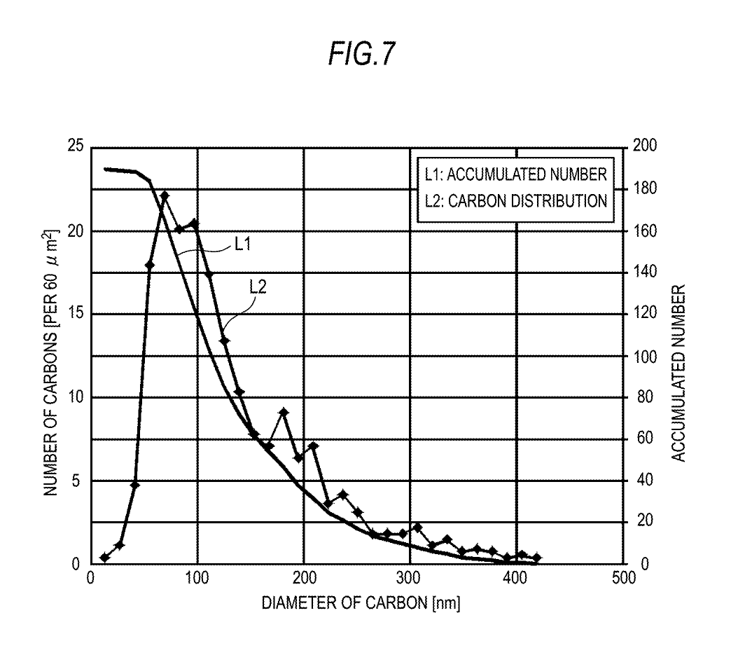

FIG. 7 shows a particle size distribution of carbon black contained in the magnetic layer-forming coating material per 60 μm². A material having the particle size distribution shown in FIG. 7 and having an average particle size of 120 nm was used as the carbon black.

### (Second Composition)

Vinyl chloride based resin A (resin solution; resin content: 30 wt %, cyclohexanone: 70 wt %): 27.8 parts by weight

n-Butyl stearate: 2 parts by weight

Methyl ethyl ketone: 121.3 parts by weight

Toluene: 121.3 parts by weight

Cyclohexanone: 60.7 parts by weight

Subsequently, a third composition having the following blending was kneaded by an extruder. Thereafter, the third composition and a fourth composition having the following blending were added in a stirring tank equipped with a disper and preliminarily mixed. Thereafter, the mixture was further mixed by a sand mill and subjected to a filtration treatment, thereby preparing a nonmagnetic layer-forming coating material.

### (Third Composition)

Acicular iron oxide powder (α-Fe₂O₃, average major axis length: 0.15 μm): 100 parts by weight

Vinyl chloride based resin A (resin solution; resin content: 30 wt %, cyclohexanone: 70 wt %): 55.6 parts by weight

Carbon black (average particle size: 20 nm): 10 parts by weight

### (Fourth Composition)

Polyurethane based resin, UR8200 (manufactured by Toyobo Co., Ltd.): 18.5 parts by weight

n-Butyl stearate: 2 parts by weight

Methyl ethyl ketone: 108.2 parts by weight

Toluene: 108.2 parts by weight

Cyclohexanone: 18.5 parts by weight

Subsequently, 4 parts by weight of a polyisocyanate (a trade name: CORONATE L, manufactured by Nippon Polyurethane Industry Co., Ltd.) as a curing agent and 2 parts by weight of myristic acid were added to each of the thus prepared magnetic layer-forming coating material and nonmagnetic layer-forming coating material.

Subsequently, the nonmagnetic layer 2 and the magnetic layer 3 were formed using these coating materials on a polyethylene naphthalate film (PEN film) which is the nonmagnetic support 1 in a wet on dry mode in the following manner. First of all, the nonmagnetic layer-forming coating material was coated on the PEN film having a thickness of 6.2 μm which is the nonmagnetic support 1 and then dried to form the nonmagnetic layer 2 on the PEN film. Subsequently, the magnetic layer-forming coating material was coated on the nonmagnetic layer 2 and then dried to form the magnetic layer 3 on the nonmagnetic layer 2. Subsequently, the PEN film having the nonmagnetic layer 2 and the magnetic layer 3 formed thereon was subjected to a calendering treatment, thereby smoothening the surface of the magnetic layer. After the calendering treatment, the nonmagnetic layer 2 and the magnetic layer 3 had an average thickness of 1,100 nm and 50 nm, respectively.

Subsequently, as the backcoat layer 4, a coating material having the following composition was coated in a film thickness of 0.6 μm on the surface opposite to the side of the magnetic layer 3 and then subjected to a drying treatment.

Carbon black (a trade name: #80, manufactured by Asahi Carbon Co., Ltd.): 100 parts by weight

Polyester polyurethane (a trade name: N-2304, manufactured by Nippon Polyurethane Industry Co., Ltd.): 100 parts by weight

Methyl ethyl ketone: 500 parts by weight

Toluene: 400 parts by weight

Cyclohexanone: 100 parts by weight

Subsequently, the PEN film in which the nonmagnetic layer 2, the magnetic layer 3 and the backcoat layer 4 had been thus formed was cut in a width of ½ inches (12.65 mm) to obtain a magnetic tape.

### Example 2

First of all, a nonmagnetic layer-forming coating material and a magnetic layer-forming coating material were prepared in the same manner as in Example 1, except that PRINTEX 25 having a particle size distribution and having an average particle size of 56 nm, which is manufactured by Evonik Degussa GmbH, was used as the carbon black to be incorporated in the magnetic layer 3.

Subsequently, the nonmagnetic layer 2 and the magnetic layer 3 were formed using these coating materials on the nonmagnetic support 1 in a wet on wet mode in the following manner. First of all, the nonmagnetic layer-forming coating material was coated on a polyethylene naphthalate film (PEN film) having a thickness of 6.2 μm, which is the nonmagnetic support 1, thereby forming a coating film on the PEN film. Subsequently, the magnetic layer-forming coating material was coated on this coating film to form a coating film. Subsequently, these coating films were dried to form the nonmagnetic layer 2 and the magnetic layer 3 on the PEN film. After the calendering treatment, the nonmagnetic layer and the magnetic layer had an average thickness of 1,100 nm and 70 nm, respectively. Thereafter, the same steps as in Example 1 were followed, thereby obtaining a sample.

### (Conduction Point Density)

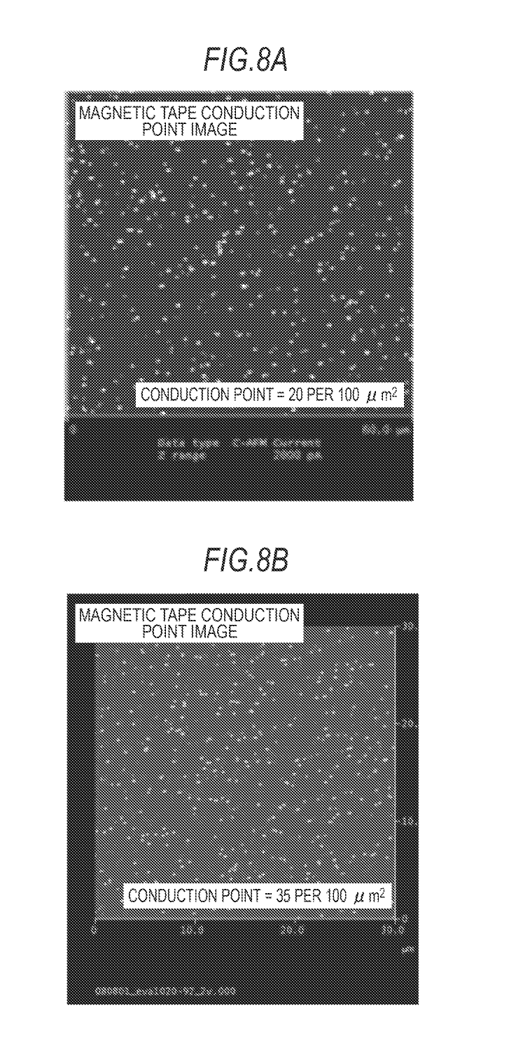

First of all, the magnetic layer 3 of each of the magnetic tapes of Examples 1 and 2 was observed in ten places chosen at random using a conductive atomic force microscope (hereinafter referred to as “C-AFM”) under the following condition. A part of the observation results is shown in FIGS. 8A and 8B.

Scanning range: 60×60 μm

Scanning speed: 1 Hz

Scan Line: 256

DC bias voltage: 2 V

Used cantilever: MESP, manufactured by Veeco Japan

Subsequently, a conduction point density (the number of conduction points per a unit area of 100 μm²) was determined for every C-AFM image in the observed ten places, and the conduction point densities in those ten places were simply added and averaged, thereby calculating an average conduction point density. As a result, in the magnetic tape of Example 1, the average conduction point density of the magnetic layer 3 was found to be 20 per 100 μm². Also, in the magnetic tape of Example 2, the average conduction point density of the magnetic layer 3 was found to be 35 per 100 μm².

As shown in FIGS. 8A and 8B, in the measurement results of C-AFM, a portion where carbon is exposed on the surface of the magnetic layer 3 is observed as a white point. In the present specification, such a point is referred to as “conduction point”. The conduction point plays a role for releasing electric charges on the surface of the magnetic tape into the nonmagnetic layer 2, thereby suppressing electrification of the magnetic tape to be caused due to frictional electrification between a magnetic head and a magnetic tape at the time of high-speed sliding. Also, the conduction point plays a role for decreasing a contact area between a magnetic head and a magnetic tape, thereby suppressing an increase of friction between the both. In the following Examples, the average conduction point density was also determined in the foregoing manner.

### (Minimum Conduction Point Particle Size)

With respect to the magnetic tape of Example 1 prepared in a wet on dry mode, the minimum conduction point particle size was examined in the following manner. The minimum conduction point particle size as referred to herein means a minimum conduction point particle size contributing to a conduction point among carbon particles (conductive particles 3a) contained in the magnetic layer 3. First of all, the carbon particle distribution of FIG. 7 was converted into the number per a unit area of 100 μm². A particle size distribution thereof is shown in FIG. 9A. Next, a particle size of the carbon particle contributing to the conduction point was determined on the basis of the thus determined average conduction point density. The results thereof are shown in FIG. 9A. As shown in FIG. 9A, it was noted that the particle size of the carbon particle contributing to the conduction point is 150 nm or more.

In Example 1, as described previously, the average conduction point density per 100 μm² was examined. As a result, the average conduction point density was found to be 20 per 100 μm². In FIG. 9A, it is assumed that among carbon particles contained in the magnetic layer 3, from a carbon particle having the largest particle size to a carbon particle up to a prescribed particle size contribute to the conduction point. On that assumption, a minimum particle size of carbon particles contributing to the conduction point can be known by determining the particle size of carbon particles in which the accumulated number counted from the carbon particle having the largest particle size is 20. In FIG. 9A, the thus determined minimum particle size of the carbon particle is 150 nm or more. Accordingly, carbon particles having a particle size of 150 nm or more are observed by C-AFM. The minimum particle size of the carbon particle of 150 nm is a value of 3 times the thickness of the magnetic layer 3 of 50 nm. In the wet on dry mode, though an interface between the nonmagnetic layer 2 and the magnetic layer 3 is distinct, the film strength is hard, and deposition of the binder is observed on the surface. In view of this fact, carbon particles larger than 3 times the thickness of the magnetic layer contribute to the conduction point.

With respect to the magnetic tape of Example 2 prepared in a wet on wet mode, a relation between the carbon particle distribution and the average conduction point density was examined in the following manner. First all, the carbon particle distribution was converted into the number per a unit area of 100 μm². A particle size distribution thereof is shown in FIG. 9B. Next, a particle size of the carbon particle contributing to the conduction point was determined on the basis of the thus determined average conduction point density of 35 per 100 μm². That is, among carbon particles contained in the magnetic layer 3, a carbon particle in which the accumulated number counted from a carbon particle having the largest particle is 35 was determined with respect to a particle size. The results thereof are shown in FIG. 9B. As shown in FIG. 9B, it was noted that the particle size of the carbon particle contributing to the conduction point is 90 nm or more. The minimum particle size of the carbon particle of 90 nm is a value of about 1.3 times the thickness of the magnetic layer 3 of 70 nm.

In the case of the wet on wet mode, since an interface between the nonmagnetic layer 2 and the magnetic layer 3 is not distinct, the carbon size capable of becoming a practically effective conduction point is small. Accordingly, it is preferable to select an optimal carbon black particle size depending upon the coating mode. In the following Examples, the minimum conduction point particle size was also determined in the foregoing manner.

### 3. Review on Relation Between the Number of Conduction Points and Friction

### Example 3

A magnetic tape having an average thickness of the magnetic layer 3 of 50 nm, a minimum conduction point particle size of 150 nm and a conduction point density of 20 per 100 μm² was prepared in a wet on dry mode in the same manner as in Example 1, except that the amount of carbon black was changed to 1.8 parts by weight based on 100 parts by weight of the amount of the magnetic powder.

### Example 4

A magnetic tape having an average thickness of the magnetic layer 3 of 50 nm, a minimum conduction point particle size of 200 nm and a conduction point density of 14 per 100 μm² was prepared in a wet on dry mode in the same manner as in Example 1, except that the amount of carbon black was changed to 1.6 parts by weight based on 100 parts by weight of the amount of the magnetic powder.

### Comparative Example 1

A magnetic tape having an average thickness of the magnetic layer 3 of 50 nm, a minimum conduction point particle size of 300 nm and a conduction point density of 9 per 100 μm² was prepared in a wet on dry mode in the same manner as in Example 1, except that the amount of carbon black was changed to 1.4 parts by weight based on 100 parts by weight of the amount of the magnetic powder.

### Comparative Example 2

A magnetic tape having an average thickness of the magnetic layer 3 of 50 nm, a minimum conduction point particle size of 360 nm and a conduction point density of 2 per 100 μm² was prepared in a wet on dry mode in the same manner as in Example 1, except that the amount of carbon black was changed to 1.2 parts by weight based on 100 parts by weight of the amount of the magnetic powder.

### (Friction)

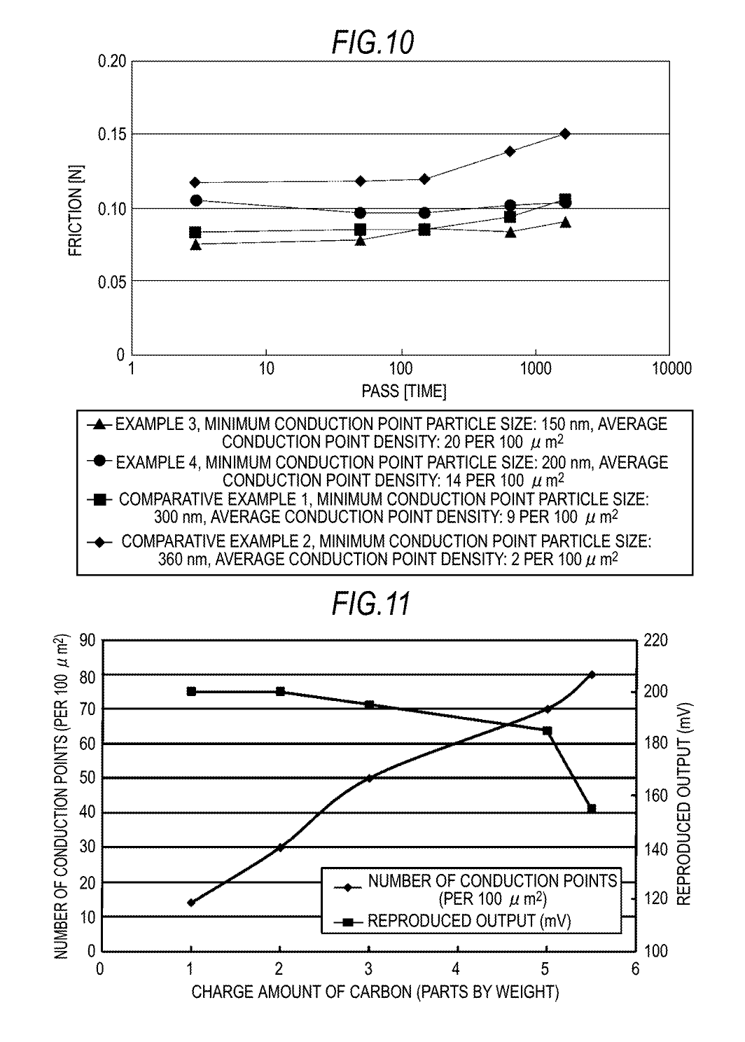

With respect to each of the magnetic tapes of Examples 3 and 4 and Comparative Examples 1 and 2, a change in friction was examined in the case of high-speed running at a tape speed of 4 m/sec using a head of LTO (tinier Tape Open) Generation 4 of a linear tape drive. All of the magnetic tapes were run 2,000 times. The results thereof are shown in FIG. 10.

As noted from FIG. 10, from the vicinity of a point of time at which the magnetic tape is run 200 times, a degree of an increase of friction of the tapes having a low conduction point density (Comparative Examples 1 and 2) becomes large, whereas a degree of an increase of friction of the tapes having a high conduction point density (Examples 3 and 4) is small, and a substantially constant friction force is kept. That is, it is noted that there is a tendency that the tapes having a high conduction point density (Examples 3 and 4) are able to suppress the increase of friction with an increase of the running time as compared with the tapes having a low conduction point density (Comparative Examples 1 and 2). Also, it is noted that there is a tendency that at a point of time at which the magnetic tape is run 2,000 times, the tapes having a high conduction point density (Examples 3 and 4) are able to decrease the friction as compared with the tapes having a low conduction point density (Comparative Examples 1 and 2). Accordingly, in the magnetic tapes prepared in a wet on dry mode, it is noted that there is a tendency that when the conduction point density is 14 or more per 100 μm², not only the increase of friction with an increase of the running time can be suppressed, but the friction can be decreased.

### 4. Review on Relation Between Minimum Conduction Point Particle Size and Reproduced Output

### Example 5-1

A magnetic tape having an average thickness of the magnetic layer 3 of 50 nm and a minimum conduction point particle size of 100 nm was prepared in a wet on dry mode in the same manner as in Example 1, except that the amount of carbon black was properly changed to 1 to 2 parts by weight based on 100 parts by weight of the amount of the magnetic powder.

### Example 5-2

A magnetic tape having an average thickness of the magnetic layer 3 of 50 nm was prepared in a wet on dry mode in the same manner as in Example 5-1, except that the minimum conduction point particle size was 150 nm.

### Example 5-3

A magnetic tape having an average thickness of the magnetic layer 3 of 50 nm was prepared in a wet on dry mode in the same manner as in Example 5-1, except that the minimum conduction point particle size was 200 nm.

### Example 5-4

A magnetic tape having an average thickness of the magnetic layer 3 of 50 nm was prepared in a wet on dry mode in the same manner as in Example 5-1, except that the minimum conduction point particle size was 250 nm.

### Comparative Example 3-1

A magnetic tape having an average thickness of the magnetic layer 3 of 50 nm was prepared in a wet on dry mode in the same manner as in Example 5-1, except that the minimum conduction point particle size was 300 nm.

### Comparative Example 3-2

A magnetic tape having an average thickness of the magnetic layer 3 of 50 nm was prepared in a wet on dry mode in the same manner as in Example 5-1, except that the minimum conduction point particle size was 350 nm.

### Comparative Example 3-3

A magnetic tape having an average thickness of the magnetic layer 3 of 50 nm was prepared in a wet on dry mode in the same manner as in Example 5-1, except that the minimum conduction point particle size was 360 nm.

### Example 6-1

A magnetic tape having an average thickness of the magnetic layer 3 of 70 nm and a minimum conduction point particle size of 100 nm was prepared in a wet on dry mode in the same manner as in Example 1, except that the amount of carbon black was properly changed to 1 to 2 parts by weight based on 100 parts by weight of the amount of the magnetic powder.

### Example 6-2

A magnetic tape having an average thickness of the magnetic layer 3 of 70 nm was prepared in a wet on dry mode in the same manner as in Example 6-1, except that the minimum conduction point particle size was 150 nm.

### Example 6-3

A magnetic tape having an average thickness of the magnetic layer 3 of 70 nm was prepared in a wet on dry mode in the same manner as in Example 6-1, except that the minimum conduction point particle size was 200 nm.

### Example 6-4

A magnetic tape having an average thickness of the magnetic layer 3 of 70 nm was prepared in a wet on dry mode in the same manner as in Example 6-1, except that the minimum conduction point particle size was 250 nm.

### Example 6-5

A magnetic tape having an average thickness of the magnetic layer 3 of 70 nm was prepared in a wet on dry mode in the same manner as in Example 6-1, except that the minimum conduction point particle size was 300 nm.

### Example 6-6

A magnetic tape having an average thickness of the magnetic layer 3 of 70 nm was prepared in a wet on dry mode in the same manner as in Example 6-1, except that the minimum conduction point particle size was 350 nm.

### Comparative Example 4-1

A magnetic tape having an average thickness of the magnetic layer 3 of 70 nm was prepared in a wet on dry mode in the same manner as in Example 6-1, except that the minimum conduction point particle size was 360 nm.

### Example 7-1

A magnetic tape having an average thickness of the magnetic layer 3 of 50 nm and a minimum conduction point particle size of 90 nm was prepared in a wet on wet mode in the same manner as in Example 2, except that the amount of carbon black was properly changed to 1 to 3 parts by weight based on 100 parts by weight of the amount of the magnetic powder.

### Example 7-2

A magnetic tape having an average thickness of the magnetic layer 3 of 50 nm was prepared in a wet on wet mode in the same manner as in Example 7-1, except that the minimum conduction point particle size was 120 nm.

### Example 7-3

A magnetic tape having an average thickness of the magnetic layer 3 of 50 nm was prepared in a wet on wet mode in the same manner as in Example 7-1, except that the minimum conduction point particle size was 150 nm.

### Comparative Example 5-1

A magnetic tape having an average thickness of the magnetic layer 3 of 50 nm was prepared in a wet on wet mode in the same manner as in Example 7-1, except that the minimum conduction point particle size was 210 nm.

### Comparative Example 5-2

A magnetic tape having an average thickness of the magnetic layer 3 of 50 nm was prepared in a wet on wet mode in the same manner as in Example 7-1, except that the minimum conduction point particle size was 220 nm.

### Comparative Example 5-3

A magnetic tape having an average thickness of the magnetic layer 3 of 50 nm was prepared in a wet on wet mode in the same manner as in Example 7-1, except that the minimum conduction point particle size was 250 nm.

### Example 8-1

A magnetic tape having an average thickness of the magnetic layer 3 of 70 nm and a minimum conduction point particle size of 90 nm was prepared in a wet on wet mode in the same manner as in Example 2, except that the amount of carbon black was properly changed to 1 to 3 parts by weight based on 100 parts by weight of the amount of the magnetic powder.

### Example 8-2

A magnetic tape having an average thickness of the magnetic layer 3 of 70 nm was prepared in a wet on wet mode in the same manner as in Example 8-1, except that the minimum conduction point particle size was 120 nm.

### Example 8-3

A magnetic tape having an average thickness of the magnetic layer 3 of 70 nm was prepared in a wet on wet mode in the same manner as in Example 8-1, except that the minimum conduction point particle size was 150 nm.

### Example 8-4

A magnetic tape having an average thickness of the magnetic layer 3 of 70 nm was prepared in a wet on wet mode in the same manner as in Example 8-1, except that the minimum conduction point particle size was 210 nm.

### Comparative Example 6-1

A magnetic tape having an average thickness of the magnetic layer 3 of 70 nm was prepared in a wet on wet mode in the same manner as in Example 8-1, except that the minimum conduction point particle size was 220 nm.

### Comparative Example 6-2

A magnetic tape having an average thickness of the magnetic layer 3 of 70 nm was prepared in a wet on wet mode in the same manner as in Example 8-1, except that the minimum conduction point particle size was 250 nm.

### (Reproduced Output)

A reproduced output of each of the thus prepared magnetic tapes of Examples 5-1 to 8-4 and Comparative Examples 3-1 to 6-2 was evaluated in the following manner. Small Form Factor, manufactured by Mountain Engineering II was used, and a recording and reproducing head mounted in LTO4 Urtrium 1840, manufactured by Hewlett Packard was used for the tape running system. A 2T output was obtained by a digital oscilloscope using an in-house designed recording and reproducing amplifier.

Table 1 shows the evaluation results of the reproduced output of each of the magnetic tapes of Examples 5-1 to 6-6 and Comparative Examples 3-1 to 4-1. Each of the magnetic tapes of Examples 5-1 to 6-6 and Comparative Examples 3-1 to 4-1 is a sample prepared in a wet on dry mode.

TABLE 1

| | | | Minimum | Volume | Particle | Reproduced output (mV) | |
|---|---|---|---|---|---|---|---|
| | | | conduction point | proportion | size of | Thickness of | Thickness of |
| | Coating | Conductive | particle size | of silica | silica | magnetic layer | magnetic layer |
| | mode | particle | (nm) | (%) | (nm) | 50 nm | 70 nm |
| Example 5-1 | WET On DRY | Carbon black | 100 | — | — | 200 | — |
| Example 5-2 | WET On DRY | Carbon black | 150 | — | — | 190 | — |
| Example 5-3 | WET On DRY | Carbon black | 200 | — | — | 180 | — |
| Example 5-4 | WET On DRY | Carbon black | 250 | — | — | 180 | — |
| Comparative | WET On DRY | Carbon black | 300 | — | — | 120 | — |
| Example 3-1 | | | | | | | |
| Comparative | WET On DRY | Carbon black | 350 | — | — | 120 | — |
| Example 3-2 | | | | | | | |
| Comparative | WET On DRY | Carbon black | 360 | — | — | 80 | — |
| Example 3-3 | | | | | | | |
| Example 6-1 | WET On DRY | Carbon black | 100 | — | — | — | 280 |
| Example 6-2 | WET On DRY | Carbon black | 150 | — | — | — | 280 |
| Example 6-3 | WET On DRY | Carbon black | 200 | — | — | — | 275 |
| Example 6-4 | WET On DRY | Carbon black | 250 | — | — | — | 275 |
| Example 6-5 | WET On DRY | Carbon black | 300 | — | — | — | 275 |
| Example 6-6 | WET On DRY | Carbon black | 350 | — | — | — | 260 |
| Comparative | WET On DRY | Carbon black | 360 | — | — | — | 230 |
| Example 4-1 | | | | | | | |

Table 2 shows the evaluation results of the reproduced output of each of the magnetic tapes of Examples 7-1 to 8-4 and Comparative Examples 5-1 to 6-2. Each of the magnetic tapes of Examples 7-1 to 8-4 and Comparative Examples 5-1 to 6-2 is a sample prepared in a wet on wet mode.

TABLE 2

| | | | Minimum | Volume | Particle | Reproduced output (mV) | |
|---|---|---|---|---|---|---|---|
| | | | conduction point | proportion | size of | Thickness of | Thickness of |
| | Coating | Conductive | particle size | of silica | silica | magnetic layer | magnetic layer |
| | mode | particle | (nm) | (%) | (nm) | 50 nm | 70 nm |
| Example 7-1 | WET On WET | Carbon black | 90 | — | — | 200 | — |
| Example 7-2 | WET On WET | Carbon black | 120 | — | — | 180 | — |
| Example 7-3 | WET On WET | Carbon black | 150 | — | — | 180 | — |
| Comparative | WET On WET | Carbon black | 210 | — | — | 120 | — |
| Example 5-1 | | | | | | | |
| Comparative | WET On WET | Carbon black | 220 | — | — | 120 | — |
| Example 5-2 | | | | | | | |
| Comparative | WET On WET | Carbon black | 250 | — | — | 120 | — |
| Example 5-3 | | | | | | | |
| Example 8-1 | WET On WET | Carbon black | 90 | — | — | — | 280 |
| Example 8-2 | WET On WET | Carbon black | 120 | — | — | — | 270 |
| Example 8-3 | WET On WET | Carbon black | 150 | — | — | — | 270 |
| Example 8-4 | WET On WET | Carbon black | 210 | — | — | — | 260 |
| Comparative | WET On WET | Carbon black | 220 | — | — | — | 240 |
| Example 6-1 | | | | | | | |
| Comparative | WET On WET | Carbon black | 250 | — | — | — | 200 |
| Example 6-2 | | | | | | | |

The following are noted from Table 1. That is, it is noted that in Examples 5-1 to 5-4 and Comparative Examples 3-1 to 3-3 in which the magnetic layer 3 having an average thickness of 50 nm is formed in a wet on dry mode, when the minimum conduction point particle size exceeds 250 nm, the reproduced output is abruptly reduced. That is, it is noted that when the minimum conduction point particle size exceeds 5 times the average thickness of the magnetic layer 3, the reproduced output is abruptly reduced. Also, it is noted that in Examples 6-1 to 6-6 and Comparative Example 4-1 in which the magnetic layer 3 having an average thickness of 70 nm is formed in a wet on dry mode, when the minimum conduction point particle size exceeds 350 nm, the reproduced output is abruptly reduced. That is, it is noted that when the minimum conduction point particle size exceeds 5 times the average thickness of the magnetic layer 3, the reproduced output is abruptly reduced.

The following are noted from Table 2. That is, it is noted that in Examples 7-1 to 7-3 and Comparative Examples 5-1 to 5-3, the magnetic layer 3 having an average thickness of 50 nm is formed in a wet on wet mode, when the minimum conduction point particle size exceeds 150 nm, the reproduced output is abruptly reduced. That is, it is noted that when the minimum conduction point particle size exceeds 3 times the average thickness of the magnetic layer 3, the reproduced output is abruptly reduced. Also, it is noted that in Examples 8-1 to 8-4 and Comparative Examples 6-1 to 6-2 in which the magnetic layer 3 having an average thickness of 70 nm is formed in a wet on wet mode, when the minimum conduction point particle size exceeds 210 nm, the reproduced output is abruptly reduced. That is, it is noted that when the minimum conduction point particle size exceeds 3 times the average thickness of the magnetic layer 3, the reproduced output is abruptly reduced.

As described previously, it may be considered that the reason why when the minimum conduction point particle size exceeds 5 times or 3 times the average thickness of the magnetic layer 3, the reproduced output is abruptly reduced resides in the fact that a part of the carbon particles is projected from the surface of the magnetic layer to form a projection, thereby producing a spacing between the magnetic head and the magnetic recording medium.

In view of the foregoing review, in the case of preparing a magnetic tape in a wet on dry mode, it is preferable that the minimum conduction point particle size is not more than 5 times the average thickness of the magnetic layer 3. Also, in the case of preparing a magnetic tape in a wet on wet mode, it is preferable that the minimum conduction point particle size is not more than 3 times the average thickness of the magnetic layer 3. Furthermore, by choosing the coating mode, the thickness of the magnetic layer, the particle size of the conductive particle and the material, it is possible to obtain a magnetic recording medium with high reliability while suppressing a reduction of the reproduced output.

### Example 9-1

A magnetic tape having an average thickness of the magnetic layer 3 of 50 nm and a conduction point density of 14 per 100 μm² was prepared in a wet on dry mode in the same manner as in Example 1, except that carbon black was added in an amount of 1 part by weight based on 100 parts by weight of the amount of the magnetic powder.

### Example 9-2

A magnetic tape having an average thickness of the magnetic layer 3 of 50 nm and a conduction point density of 30 per 100 μm² was prepared in a wet on dry mode in the same manner as in Example 1, except that carbon black was added in an amount of 2 parts by weight based on 100 parts by weight of the amount of the magnetic powder.

### Example 9-3

A magnetic tape having an average thickness of the magnetic layer 3 of 50 nm and a conduction point density of 50 per 100 μm² was prepared in a wet on dry mode in the same manner as in Example 1, except that carbon black was added in an amount of 3 parts by weight based on 100 parts by weight of the amount of the magnetic powder.

### Example 9-4

A magnetic tape having an average thickness of the magnetic layer 3 of 50 nm and a conduction point density of 70 per 100 μm² was prepared in a wet on dry mode in the same manner as in Example 1, except that carbon black was added in an amount of 5 parts by weight based on 100 parts by weight of the amount of the magnetic powder.

### Comparative Example 7-1

A magnetic tape having an average thickness of the magnetic layer 3 of 50 nm and a conduction point density of 80 per 100 μm² was prepared in a wet on dry mode in the same manner as in Example 1, except that carbon black was added in an amount of 5.5 parts by weight based on 100 parts by weight of the amount of the magnetic powder.

### (Reproduced Output)

A reproduced output of each of the thus prepared magnetic tapes of Examples 9-1 to 9-4 and Comparative Example 7-1 was evaluated in the following manner. Small Form Factor, manufactured by Mountain Engineering II was used, and a recording and reproducing head mounted in LTO4 Urtrium 1840, manufactured by Hewlett Packard was used for the tape running system. A 2T output was obtained by a digital oscilloscope using an in-house designed recording and reproducing amplifier. The results are shown in Table 3 and FIG. 11.

Table 3 shows the evaluation results of the reproduced output of each of the magnetic tapes of Examples 9-1 to 9-4 and Comparative Example 7-1.

TABLE 3

| | | | Charge amount of | Number of | Reproduced output (mV) |
|---|---|---|---|---|---|
| | Coating | Conductive | conductive particle | conduction points | Thickness of magnetic |
| | mode | particle | (parts by weight) | (per 100 μm²) | layer 50 nm |
| Example 9-1 | WET On DRY | Carbon black | 1 | 1400 | 200 |
| Example 9-2 | WET On DRY | Carbon black | 2 | 3000 | 200 |
| Example 9-3 | WET On DRY | Carbon black | 3 | 5000 | 195 |
| Example 9-4 | WET On DRY | Carbon black | 5 | 7000 | 185 |
| Comparative | WET On DRY | Carbon black | 5.5 | 8000 | 155 |
| Example 7-1 | | | | | |

The following are noted from Table 3 and FIG. 11.

There is a tendency that as the charge amount of carbon increases, the number of conduction points increases.

In the range where the charge amount of carbon is from 1 to 5 parts by weight, there is a tendency that as the charge amount of carbon increases, the reproduced output is slightly lowered. On the contrary, in the range of the charge amount of carbon exceeding 5 parts by weight, there is a tendency that the reproduced output is abruptly lowered. Accordingly, from the viewpoint of suppressing a lowering of the reproduced output, it is preferable that the charge amount of carbon is in the range of from 1 to 5 parts by weight based on 100 parts by weight of the magnetic powder.

In the range where the number of conduction points is from 14 to 70 per 100 μm², there is a tendency that as the number of conduction points increases, the reproduced output is slightly lowered. On the contrary, in the range where the number of conduction points exceeds 70 per 100 μm², there is a tendency that the reproduced output is abruptly lowered. Accordingly, from the viewpoint of suppressing a lowering of the reproduced output, it is preferable that the number of conduction points is not more than 70 per 100 μm².

### 5. Review on Relation Between Minimum Conduction Point Particle Size and Error Rate

### Example 10

A magnetic tape having an average thickness of the magnetic layer 3 of 50 nm, a minimum conduction point particle size of 150 nm and a conduction point density of 20 per 100 μm² was prepared in a wet on dry mode in the same manner as in Example 1, except that the amount of carbon black was properly changed to 1 to 2 parts by weight based on 100 parts by weight of the amount of the magnetic powder.

### Example 11

A magnetic tape having an average thickness of the magnetic layer 3 of 50 nm, a minimum conduction point particle size of 200 nm and a conduction point density of 14 per 100 μm² was prepared in a wet on dry mode in the same manner as in Example 1, except that the amount of carbon black was properly changed to 1 to 2 parts by weight based on 100 parts by weight of the amount of the magnetic powder.

### Comparative Example 8

A magnetic tape having an average thickness of the magnetic layer 3 of 50 nm, a minimum conduction point particle size of 300 nm and a conduction point density of 9 per 100 μm² was prepared in a wet on dry mode in the same manner as in Example 1, except that the amount of carbon black was properly changed to 1 to 2 parts by weight based on 100 parts by weight of the amount of the magnetic powder.

### Comparative Example 9

A magnetic tape having an average thickness of the magnetic layer 3 of 50 nm, a minimum conduction point particle size of 360 nm and a conduction point density of 2 per 100 μm² was prepared in a wet on dry mode in the same manner as in Example 1, except that the amount of carbon black was properly changed to 1 to 2 parts by weight based on 100 parts by weight of the amount of the magnetic powder.

### Example 12

A magnetic tape having an average thickness of the magnetic layer 3 of 70 nm, a minimum conduction point particle size of 90 nm and a conduction point density of 35 per 100 μm² was prepared in a wet on wet mode in the same manner as in Example 2, except that the amount of carbon black was properly changed to 1 to 3 parts by weight based on 100 parts by weight of the amount of the magnetic powder.

### Example 13

A magnetic tape having an average thickness of the magnetic layer 3 of 70 nm, a minimum conduction point particle size of 120 nm and a conduction point density of 15 per 100 μm² was prepared in a wet on wet mode in the same manner as in Example 2, except that the amount of carbon black was properly changed to 1 to 3 parts by weight based on 100 parts by weight of the amount of the magnetic powder.

### Comparative Example 10

A magnetic tape having an average thickness of the magnetic layer 3 of 70 nm, a minimum conduction point particle size of 220 nm and a conduction point density of 2 per 100 μm² was prepared in a wet on wet mode in the same manner as in Example 2, except that the amount of carbon black was properly changed to 1 to 3 parts by weight based on 100 parts by weight of the amount of the magnetic powder.

### (Error Rate)

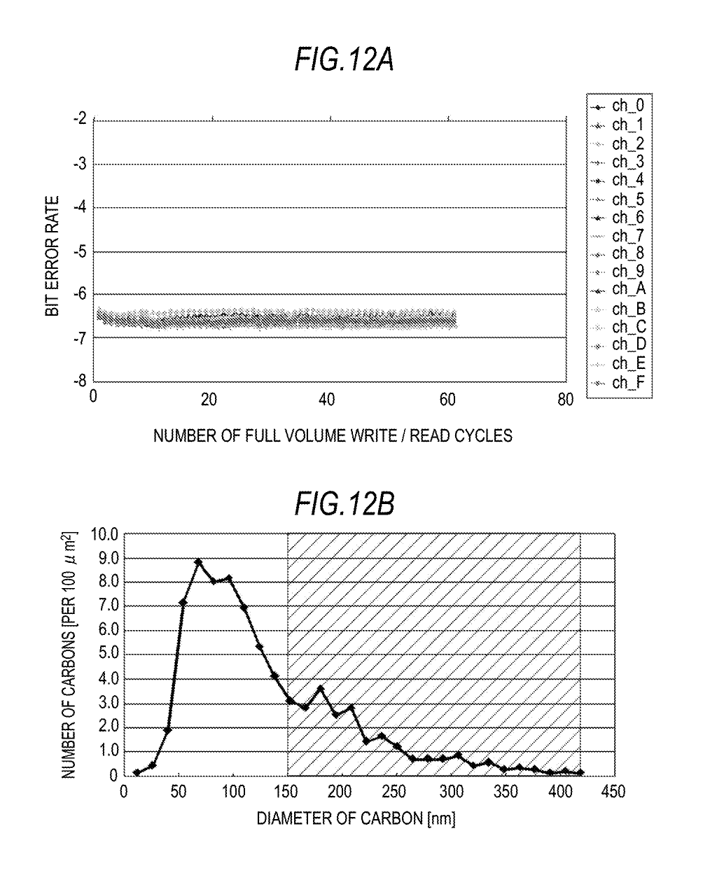

An error rate of each of the thus prepared magnetic tapes of Examples 10 to 13 and Comparative Examples 8 to 10 was evaluated in the following manner. Small Form Factor, manufactured by Mountain Engineering II was used, and a recording and reproducing head mounted in an LTO4 drive, manufactured by Hewlett Packard was used for the tape running system. An in-house designed recording and reproducing amplifier was used, and an M-series random signal was used as an input signal. The evaluation results are shown in FIGS. 12A to 18B.

As shown in FIG. 12A, in Example 10, the error rate became substantially constant without recourse to the read/write cycle number on the magnetic tape. In Example 10, the carbon particle having a minimum conduction point particle size of 150 nm contributes to the conduction point (see FIG. 12B). This minimum conduction point particle size of 150 nm is a value of 3 times the thickness of the magnetic layer 3.

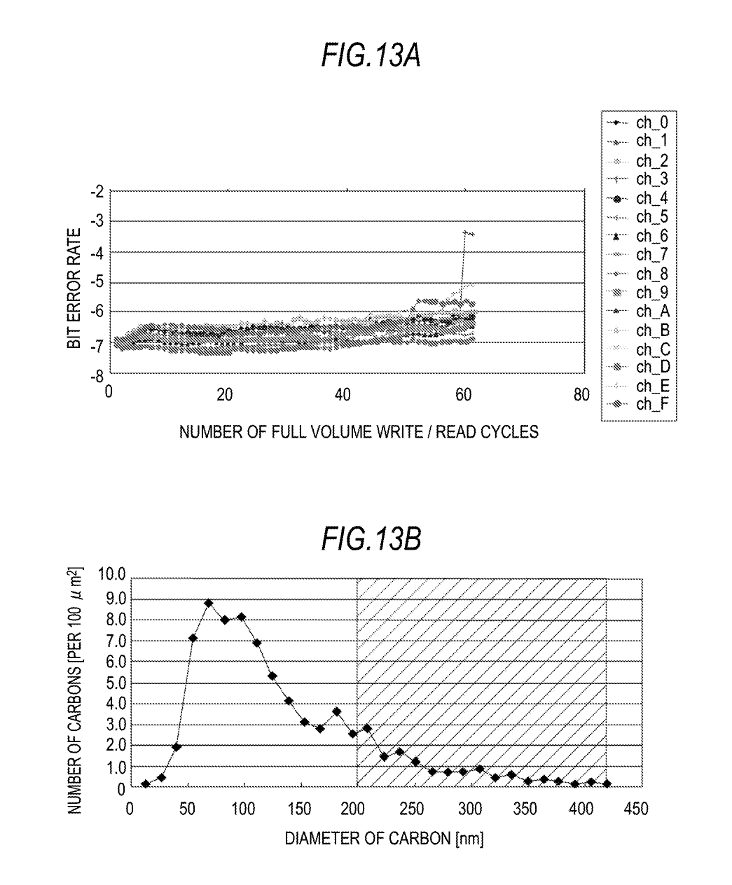

As shown in FIG. 13A, in Example 11, though the error rate slightly increased with an increase of the read/write cycle number on the magnetic tape, it became substantially constant. In Example 11, the carbon particle having a minimum conduction point particle size of 200 nm contributes to the conduction point (see FIG. 13B). This minimum conduction point particle size of 200 nm is a value of 4 times the thickness of the magnetic layer 3.

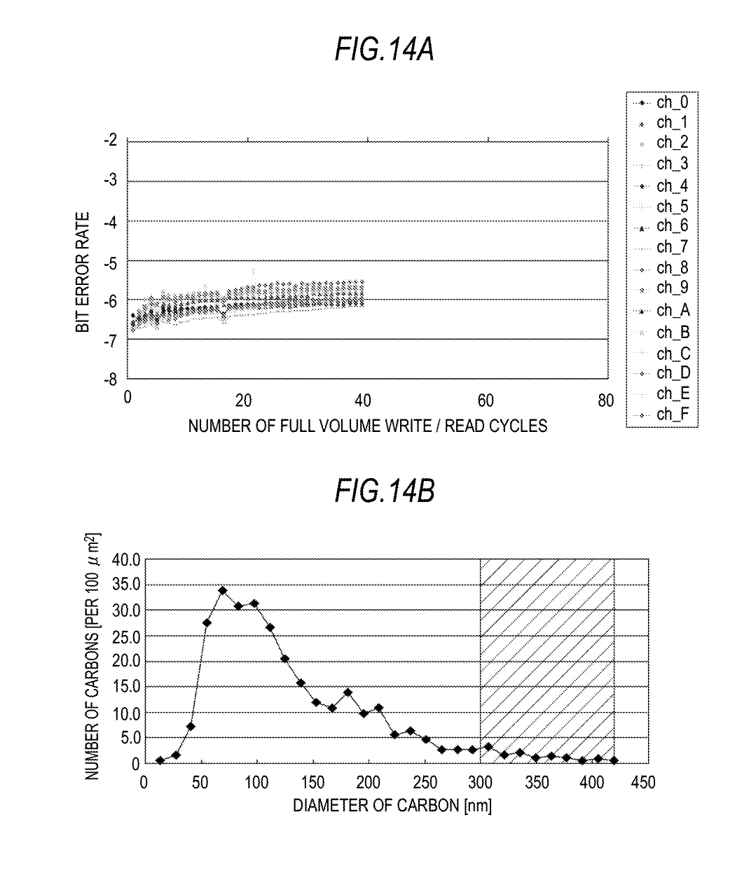

As shown in FIG. 14A, in Comparative Example 8, the error rate increased with an increase of the read/write cycle number on the magnetic tape. In Comparative Example 8, the carbon particle having a minimum conduction point particle size of 300 nm contributes to the conduction point (see FIG. 14B). This minimum conduction point particle size of 300 nm is a value of 6 times the thickness of the magnetic layer 3.

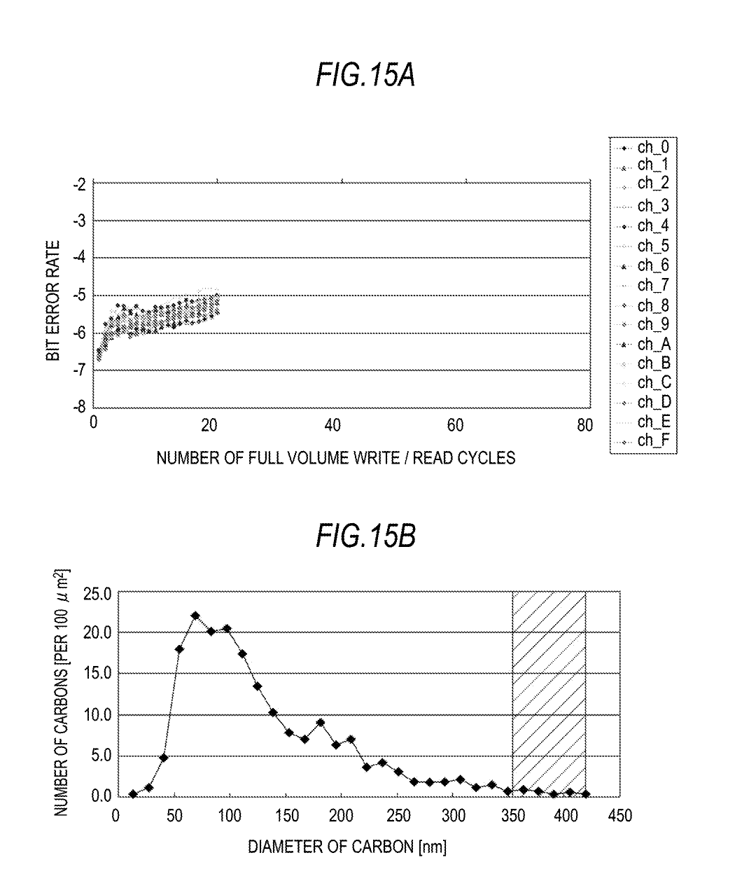

As shown in FIG. 15A, in Comparative Example 9, the error rate increased with an increase of the read/write cycle number on the magnetic tape. In Comparative Example 9, the carbon particle having a minimum conduction point particle size of 360 nm contributes to the conduction point (see FIG. 15B). This minimum conduction point particle size of 360 nm is a value of 7.2 times the thickness of the magnetic layer 3.

From the results shown in FIGS. 12A to 15B, in the magnetic tapes prepared in a wet on dry mode, it is noted that there is a tendency that when the minimum conduction point particle size is 3 times or more and not more than 5 times the thickness of the magnetic layer 3, the error rate can be decreased.

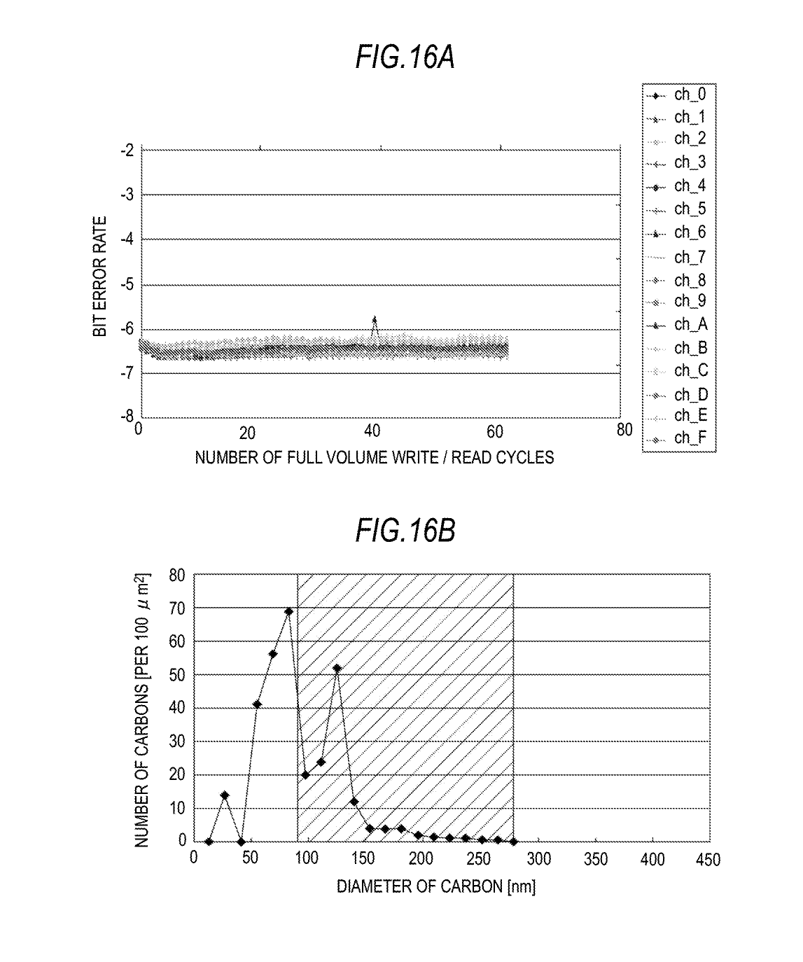

Also, as shown in FIG. 16A, in Example 12, the error rate became substantially constant without recourse to the read/write cycle number on the magnetic tape. In Example 12, the carbon particle having a minimum conduction point particle size of 90 nm contributes to the conduction point (see FIG. 16B). This minimum conduction point particle size of 90 nm is a value of about 1.3 times the thickness of the magnetic layer 3.

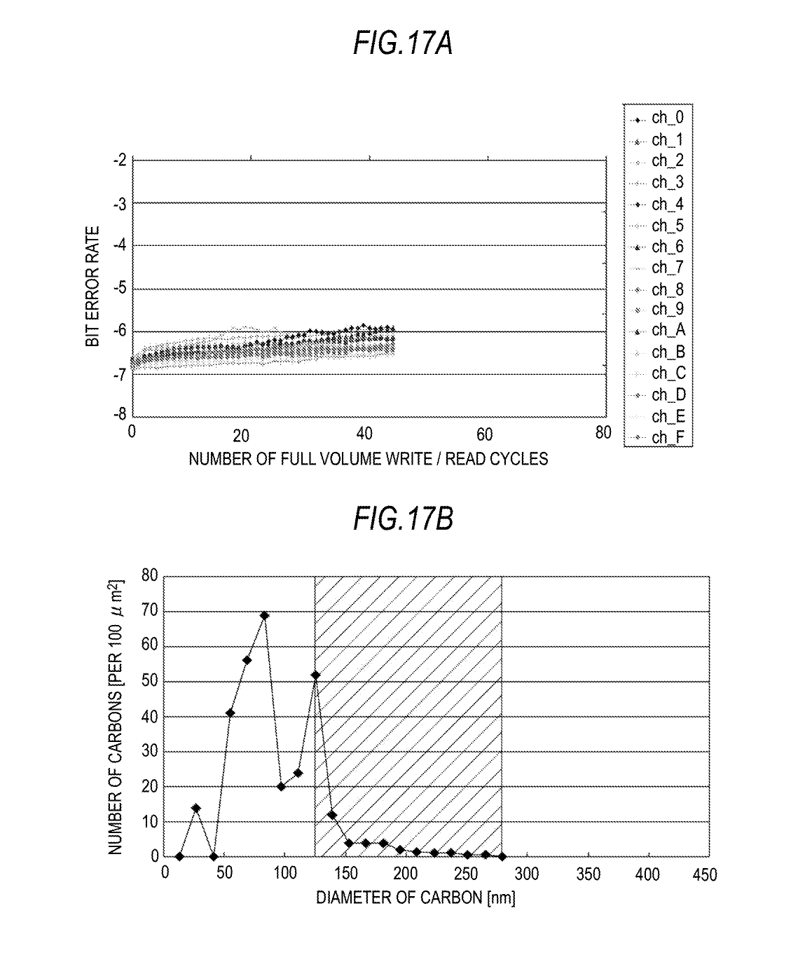

As shown in FIG. 17A, in Example 13, though the error rate slightly increased with an increase of the read/write cycle number on the magnetic tape, it became substantially constant. In Example 13, the carbon particle having a minimum conduction point particle size of 120 nm contributes to the conduction point (see FIG. 17B). This minimum conduction point particle size of 120 nm is a value of about 1.7 times the thickness of the magnetic layer 3.

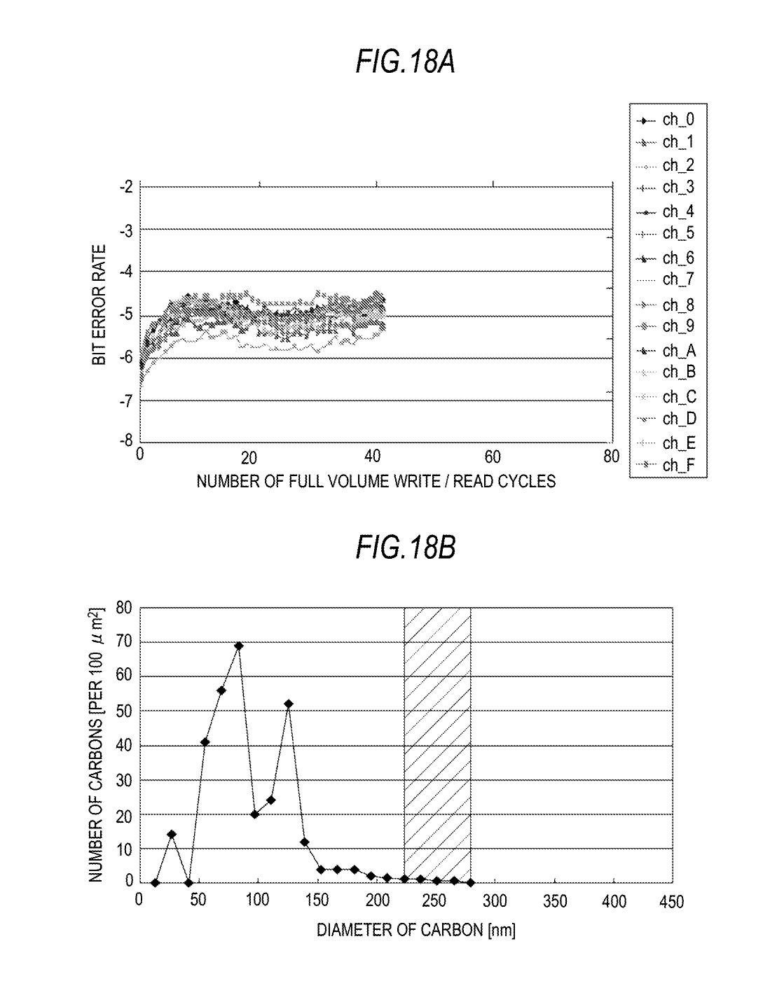

As shown in FIG. 18A, in Comparative Example 10, the error rate increased with an increase of the read/write cycle number on the magnetic tape. In Comparative Example 10, the carbon particle having a minimum conduction point particle size of 220 nm contributes to the conduction point (see FIG. 18B). This minimum conduction point particle size of 220 nm is a value of about 3.1 times the thickness of the magnetic layer 3.

From the results shown in FIGS. 16A to 18B, in the magnetic tapes prepared in a wet on wet mode, it is noted that there is a tendency that when the minimum conduction point particle size is 1.3 times or more and not more than 3 times the thickness of the magnetic layer 3, the error rate can be decreased. Also, in the magnetic tapes prepared in a wet on wet mode, it is noted that there is a tendency that when the conduction point density is 15 or more per 100 μm², the error rate can be decreased.

### 6. Review on the Case of Using Hybrid Carbon

In the case where hybrid carbon in which carbon is attached to the surface of a silica particle is used as the conductive particle 3a in place of the carbon black, the friction, the reproduced output and the error rate are reviewed.

### Examples 14-1 to 14-3

Hybrid carbons in which a volume proportion of silica showing a proportion of the volume of the silica particle relative to the volume of hybrid carbon is 18%, 40% and 80%, respectively were prepared. Magnetic tapes having an average thickness of the magnetic layer 3 of 50 nm and a minimum conduction point particle size of from 211 nm to 243 nm were prepared in a wet on dry mode in the same manner as in Example 1, except that hybrid carbon was used in placed of the carbon black and that the amount of hybrid carbon was properly changed to 0.2 to 1.6 parts by weight based on 100 parts by weight of the amount of the magnetic powder.

### Examples 15-1 to 15-3

Magnetic tapes having an average thickness of the magnetic layer 3 of 50 nm, a minimum conduction point particle size in the range of from 106 nm to 122 nm and a volume proportion of silica in the range of from 18% to 80% were prepared in a wet on wet mode in the same manner as in Example 2, except that each of hybrid carbons having a volume proportion of 18%, 40% and 80%, respectively was used in place of the carbon black and that the amount of hybrid carbon was properly changed to 0.2 to 1.6 parts by weight based on 100 parts by weight of the amount of the magnetic powder.

### Examples 16-1 to 16-2 and Comparative Examples 11-1 to 11-3

Hybrid carbons having a minimum conduction point particle size of 95 nm, 112 nm, 150 nm, 250 nm and 260 nm, respectively were prepared. Magnetic tapes having an average thickness of the magnetic layer 3 of 50 nm and a volume proportion of silica of 40% were prepared in a wet on dry mode in the same manner as in Example 1, except that hybrid carbon was used in place of the carbon black and that the amount of hybrid carbon was properly changed to 0.2 to 1.6 parts by weight based on 100 parts by weight of the amount of the magnetic powder.

### Examples 17-1 to 17-2 and Comparative Examples 12-1 to 12-3

Magnetic tapes having an average thickness of the magnetic layer 3 of 50 nm and a volume proportion of silica of 40% were prepared in a wet on wet mode in the same manner as in Example 2, except that each of hybrid carbons having a minimum conduction point particle size of 50 nm, 65 nm, 150 nm, 160 nm and 246 nm, respectively was used in place of the carbon black and that the amount of hybrid carbon was properly changed to 0.2 to 1.6 parts by weight based on 100 parts by weight of the amount of the magnetic powder.

### (Friction)

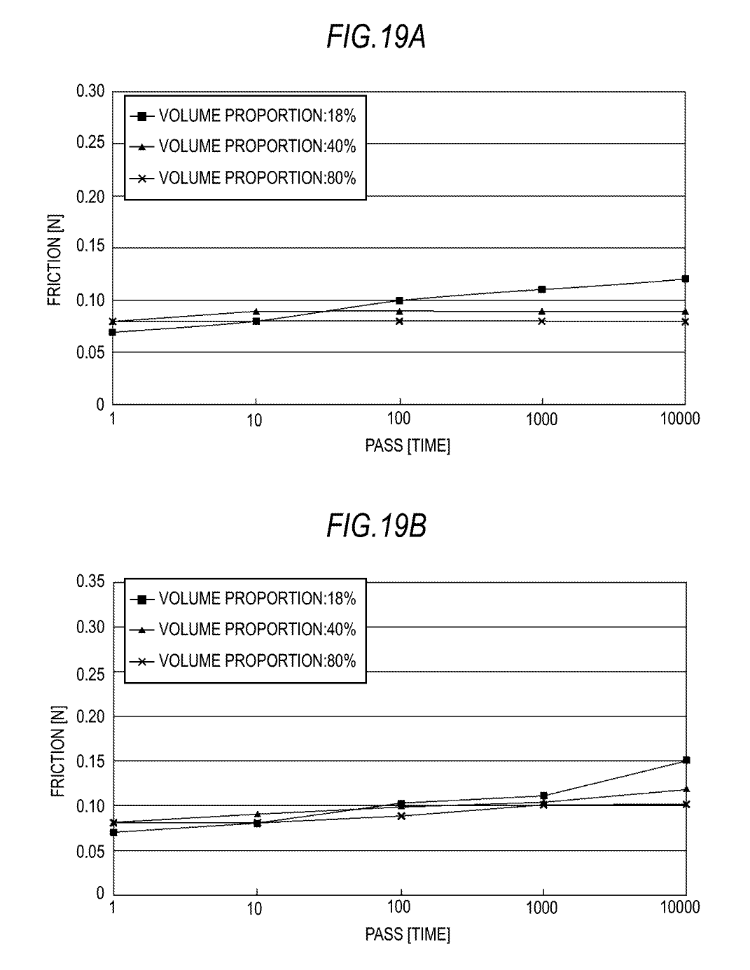

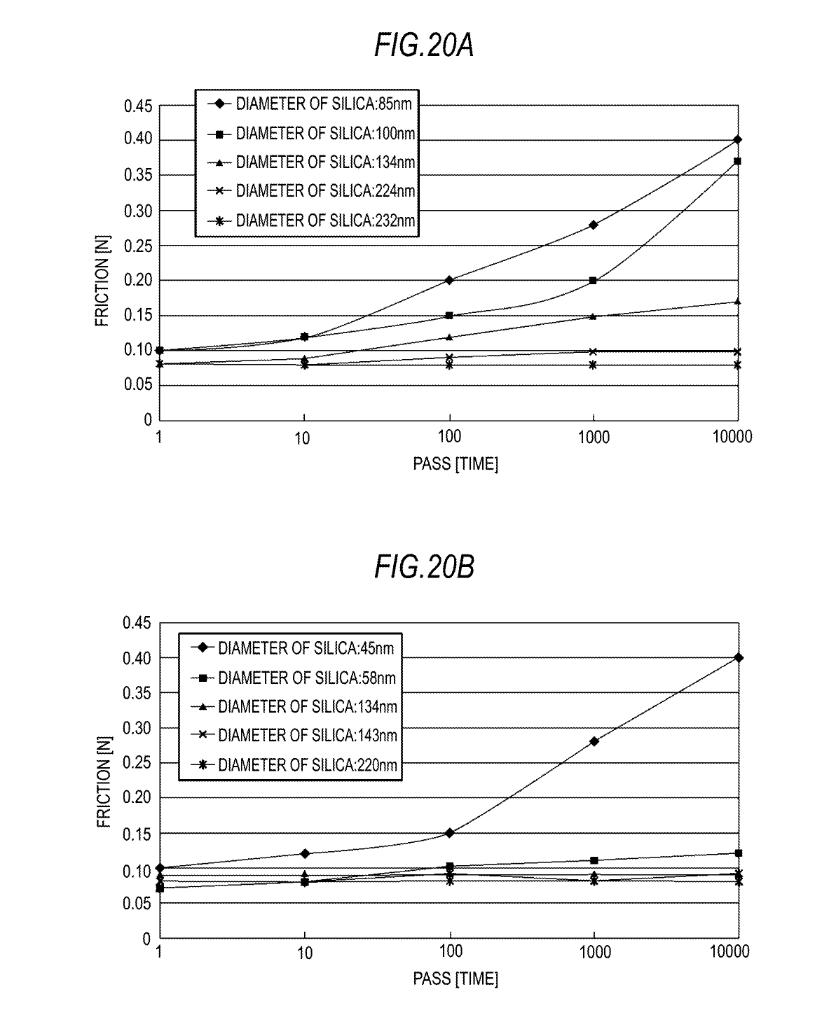

With respect to each of the magnetic tapes of Examples 14-1 to 17-2 and Comparative Examples 11-1 to 12-3, a change in friction was examined in the case of high-speed running at a tape speed of 4 m/sec using a head of LTO Generation 4 of a linear tape drive. All of the magnetic tapes were run 10,000 times. The results thereof are shown in FIGS. 19A to 20B.

As noted from FIG. 19A, a degree of an increase of friction of the magnetic tapes having a volume proportion of silica of from 18% to 40% in a wet on dry mode (Examples 14-1 to 14-3) is small as the magnetic tape is run, and a substantially constant friction force is kept.

As noted from FIG. 19B, a degree of an increase of friction of the magnetic tapes having a volume proportion of silica of from 18% to 40% in a wet on wet mode (Examples 15-1 to 15-3) is small as the magnetic tape is run, and a substantially constant friction force is kept.

As noted from FIG. 20A, as the magnetic tape is run, a degree of an increase of friction of the tapes having a small minimum conduction point particle size (Comparative Examples 11-1 to 11-2) becomes large, whereas a degree of an increase of friction of the tapes having a large minimum conduction point particle size (Examples 16-1 to 16-2 and Comparative Example 11-3) is small, and a substantially constant friction force is kept. That is, it is noted that there is a tendency that the tapes having a large minimum conduction point particle size (Examples 16-1 to 16-2 and Comparative Example 11-3) are able to suppress the increase of friction with an increase of the running time as compared with the tapes having a small minimum conduction point particle size (Comparative Examples 11-1 to 11-2). Also, it is noted that there is a tendency that at a point of time at which the magnetic tape is run 10,000 times, the tapes having a large minimum conduction point particle size (Examples 16-1 to 16-2 and Comparative Example 11-3) are able to decrease the friction as compared with the tapes having a small minimum conduction point particle size (Comparative Examples 11-1 to 11-2).

As noted from FIG. 20B, as the magnetic tape is run, a degree of an increase of friction of the tape having a small minimum conduction point particle size (Comparative Example 12-1) becomes large, whereas a degree of an increase of friction of the tapes having a large minimum conduction point particle size (Examples 17-1 to 17-2 and Comparative Examples 12-2 to 12-3) is small, and a substantially constant friction force is kept. That is, it is noted that there is a tendency that the tapes having a large minimum conduction point particle size (Examples 17-1 to 17-2 and Comparative Examples 12-2 to 12-3) are able to suppress the increase of friction with an increase of the running time as compared with the tape having a small minimum conduction point particle size (Comparative Example 12-1). Also, it is noted that there is a tendency that at a point of time at which the magnetic tape is run 10,000 times, the tapes having a large minimum conduction point particle size (Examples 17-1 to 17-2 and Comparative Examples 12-2 to 12-3) are able to decrease the friction as compared with the tape having a small minimum conduction point particle size (Comparative Example 12-1).

### (Reproduced Output)

A reproduced output of each of the thus prepared magnetic tapes of Examples 14-1 to 17-2 and Comparative Examples 11-1 to 12-3 was evaluated in the following manner. Small Form Factor, manufactured by Mountain Engineering II was used, and a recording and reproducing head mounted in LTO4 Urtrium 1840, manufactured by Hewlett Packard was used for the tape running system. A 2T output was obtained by a digital oscilloscope using an in-house designed recording and reproducing amplifier.

Table 4 shows the evaluation results of the reproduced output of each of the magnetic tapes of Examples 14-1 to 15-3. Each of the magnetic tapes of Examples 14-1 to 14-3 is a sample prepared in a wet on dry mode; and each of the magnetic tapes of Examples 15-1 to 15-3 is a sample prepared in a wet on wet mode.

TABLE 4

| | | | Minimum | Volume | Particle | Reproduced output (mV) | |
|---|---|---|---|---|---|---|---|
| | | | conduction point | proportion | size of | Thickness of | Thickness of |
| | Coating | Conductive | particle size | of silica | silica | magnetic layer | magnetic layer |
| | mode | particle | (nm) | (%) | (nm) | 50 nm | 70 nm |
| Example 14-1 | WET On DRY | Hybrid carbon | 211 | 18 | 200 | 215 | — |
| Example 14-2 | WET On DRY | Hybrid carbon | 224 | 40 | 200 | 215 | — |
| Example 14-3 | WET On DRY | Hybrid carbon | 243 | 80 | 200 | 210 | — |
| Example 15-1 | WET On WET | Hybrid carbon | 106 | 18 | 100 | 220 | — |
| Example 15-2 | WET On WET | Hybrid carbon | 112 | 40 | 100 | 220 | — |
| Example 15-3 | WET On WET | Hybrid carbon | 122 | 80 | 100 | 210 | — |

Table 5 shows the evaluation results of the reproduced output of each of the magnetic tapes of Examples 16-1 to 17-2 and Comparative Examples 11-1 to 12-3. Each of the magnetic tapes of Examples 16-1 to 16-2 and Comparative Examples 11-1 to 11-3 is a sample prepared in a wet on dry mode; and each of the magnetic tapes of Examples 17-1 to 17-2 and Comparative Examples 12-1 to 12-3 is a sample prepared in a wet on wet mode.

TABLE 5

| | | | Minimum | Volume | Particle | Reproduced output (mV) | |
|---|---|---|---|---|---|---|---|
| | | | conduction point | proportion | size of | Thickness of | Thickness of |
| | Coating | Conductive | particle size | of silica | silica | magnetic layer | magnetic layer |
| | mode | particle | (nm) | (%) | (nm) | 50 nm | 70 nm |
| Comparative | WET On DRY | Hybrid carbon | 95 | 40 | 85 | 215 | — |
| Example 11-1 | | | | | | | |
| Comparative | WET On DRY | Hybrid carbon | 112 | 40 | 100 | 215 | — |
| Example 11-2 | | | | | | | |
| Example 16-1 | WET On DRY | Hybrid carbon | 150 | 40 | 134 | 215 | — |
| Example 16-2 | WET On DRY | Hybrid carbon | 250 | 40 | 224 | 210 | — |
| Comparative | WET On DRY | Hybrid carbon | 260 | 40 | 232 | 185 | — |
| Example 11-3 | | | | | | | |
| Comparative | WET On WET | Hybrid carbon | 50 | 40 | 45 | 215 | — |
| Example 12-1 | | | | | | | |
| Example 17-1 | WET On WET | Hybrid carbon | 65 | 40 | 58 | 215 | — |
| Example 17-2 | WET On WET | Hybrid carbon | 150 | 40 | 134 | 215 | — |
| Comparative | WET On WET | Hybrid carbon | 160 | 40 | 143 | 185 | — |
| Example 12-2 | | | | | | | |
| Comparative | WET On WET | Hybrid carbon | 246 | 40 | 220 | 160 | — |
| Example 12-3 | | | | | | | |

The following are noted from Table 4. That is, in Examples 14-1 to 14-3 in which the magnetic layer 3 is formed in a wet on dry mode, in the case where the volume proportion of silica is from 18% to 80%, an adequate reproduced output can be obtained. Also, in Examples 15-1 to 15-3 in which the magnetic layer 3 is formed in a wet on wet mode, in the case where the volume proportion of silica is from 18% to 80%, an adequate reproduced output can be obtained.

The following are noted from Table 5. That is, in Examples 16-1 to 16-2 and Comparative Examples 11-1 to 11-3 in which the magnetic layer 3 is formed in a wet on dry mode, it is noted that when the minimum conduction point particle size exceeds 250 nm, the reproduced output is abruptly reduced. That is, it is noted that when the minimum conduction point particle size exceeds 5 times the average thickness of the magnetic layer 3, the reproduced output is abruptly reduced. Also, in Examples 17-1 to 17-2 and Comparative Examples 12-1 to 12-3 in which the magnetic layer 3 is formed in a wet on wet mode, it is noted that when the minimum conduction point particle size exceeds 150 nm, the reproduced output is abruptly reduced. That is, it is noted that when the minimum conduction point particle size exceeds 3 times the average thickness of the magnetic layer 3, the reproduced output is abruptly reduced.

As described previously, it may be considered that the reason why when the minimum conduction point particle size exceeds 250 nm or 150 nm (5 times or 3 times the average thickness of the magnetic layer 3), the reproduced output is abruptly reduced resides in the fact that a part of the carbon particles is projected from the surface of the magnetic layer to form a projection, thereby producing a spacing between the magnetic head and the magnetic recording medium.

In view of the foregoing review, in the case of preparing a magnetic tape using hybrid carbon in a wet on dry mode, it is preferable that the volume proportion of silica is not more than 80%. Also, it is preferable that the minimum conduction point particle size is not more than 250 nm (not more than 5 times the average thickness of the magnetic layer 3).

Also, in the case of preparing a magnetic tape using hybrid carbon in a wet on wet mode, it is preferable that the volume proportion of silica is not more than 80%. Also, it is preferable that the minimum conduction point particle size is not more than 150 nm (not more than 3 times the average thickness of the magnetic layer 3).

Furthermore, by choosing the coating mode, the thickness of the magnetic layer, the particle size of the conductive particle and the material, it is possible to obtain a magnetic recording medium with high reliability while suppressing a reduction of the reproduced output.

### (Error Rate)

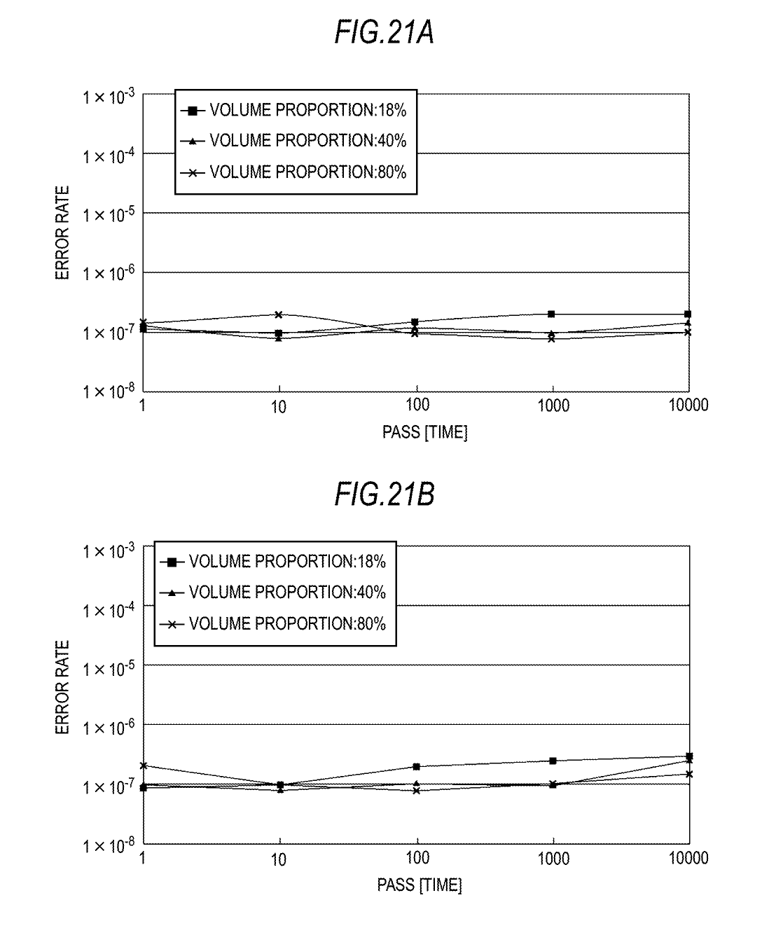

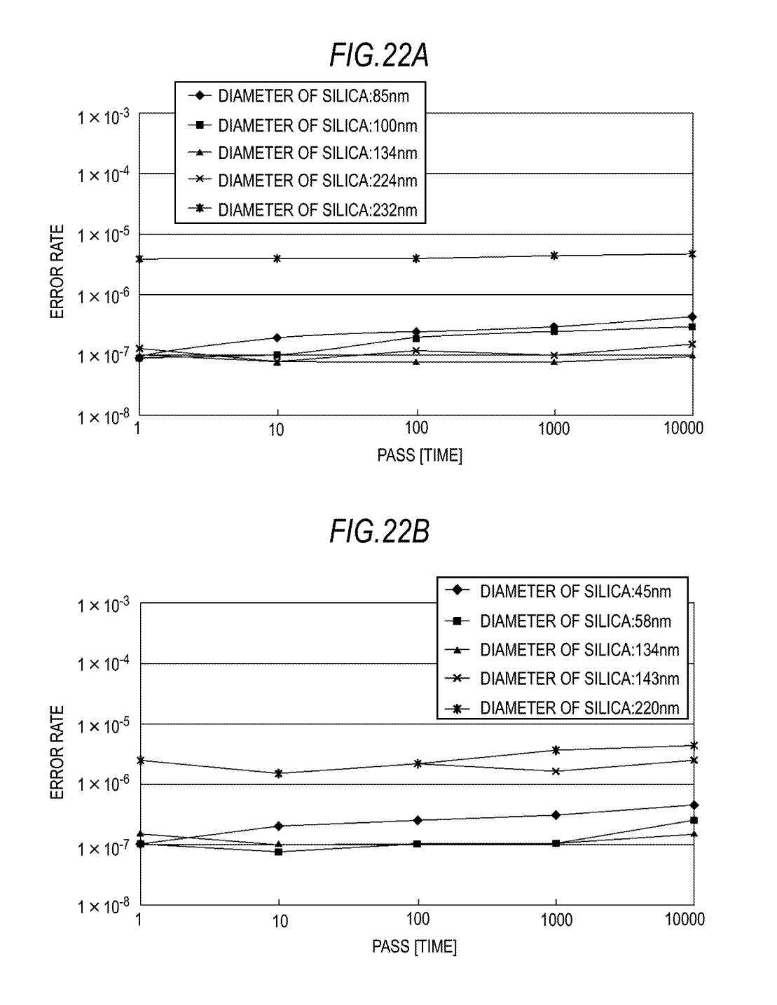

An error rate of each of the thus prepared magnetic tapes of Examples 14-1 to 17-2 and Comparative Examples 11-1 to 12-3 was evaluated in the following manner. Small Form Factor, manufactured by Mountain Engineering II was used, and a recording and reproducing head mounted in an LTO4 drive, manufactured by Hewlett Packard was used for the tape running system. An in-house designed recording and reproducing amplifier was used, and an M-series random signal was used as an input signal. The evaluation results are shown in FIGS. 21A to 22B.

As shown in FIG. 21A, in Example 14-1, though the error rate slightly increased with an increase of the read/write cycle number on the magnetic tape, it became substantially constant. In Examples 14-2 and 14-3, the error rate became substantially constant without recourse to the read/write cycle number on the magnetic tape. In Examples 14-1 to 14-3, the hybrid carbon having a minimum conduction point particle size of from 211 nm to 243 nm contributes to the conduction point. This minimum conduction point particle size of 243 nm is a value of about 4.9 times the thickness of the magnetic layer 3.

As shown in FIG. 21B, in Examples 15-1 to 15-2, though the error rate slightly increased with an increase of the read/write cycle number on the magnetic tape, it became substantially constant. In Example 15-3, the error rate became substantially constant without recourse to the read/write cycle number on the magnetic tape. In Examples 15-1 to 15-3, the hybrid carbon having a minimum conduction point particle size of from 106 nm to 122 nm contributes to the conduction point. This minimum conduction point particle size of 122 nm is a value of about 2.4 times the thickness of the magnetic layer 3.

As shown in FIG. 22A, in Example 16-1, the error rate became substantially constant without recourse to the read/write cycle number on the magnetic tape. In Example 16-1, the hybrid carbon having a minimum conduction point particle size of from 150 nm contributes to the conduction point. This minimum conduction point particle size of 150 nm is a value of 3 times the thickness of the magnetic layer 3.

In Example 16-2, the error rate became substantially constant without recourse to the read/write cycle number on the magnetic tape. In Example 16-2, the hybrid carbon having a minimum conduction point particle size of from 250 nm contributes to the conduction point. This minimum conduction point particle size of 250 nm is a value of 5 times the thickness of the magnetic layer 3.

In Comparative Example 11-1, though the error rate slightly increased with an increase of the read/write cycle number on the magnetic tape, it became substantially constant. In Comparative Example 11-1, the hybrid carbon having a minimum conduction point particle size of 95 nm contributes to the conduction point. This minimum conduction point particle size of 95 nm is a value of 1.9 times the thickness of the magnetic layer 3.

In Comparative Example 11-2, though the error rate slightly increased with an increase of the read/write cycle number on the magnetic tape, it became substantially constant. In Comparative Example 11-2, the hybrid carbon having a minimum conduction point particle size of 112 nm contributes to the conduction point. This minimum conduction point particle size of 112 nm is a value of about 2.2 times the thickness of the magnetic layer 3.

On the other hand, in Comparative Example 11-3, though the error rate became substantially constant without recourse to the read/write cycle number on the magnetic tape, the error rate was in the order of the sixth power at a stage of the beginning of cycle and fell outside the specification of LTO. In Comparative Example 11-3, the hybrid carbon having a minimum conduction point particle size of 260 nm contributes to the conduction point. This minimum conduction point particle size of 260 nm is a value of 5.2 times the thickness of the magnetic layer 3.

As shown in FIG. 22B, in Example 17-1, the error rate became substantially constant without recourse to the read/write cycle number on the magnetic tape. In Example 17-1, the hybrid carbon having a minimum conduction point particle size of 65 nm contributes to the conduction point. This minimum conduction point particle size of 65 nm is a value of 1.3 times the thickness of the magnetic layer 3.

In Example 17-2, the error rate became substantially constant without recourse to the read/write cycle number on the magnetic tape. In Example 17-2, the hybrid carbon having a minimum conduction point particle size of 150 nm contributes to the conduction point. This minimum conduction point particle size of 150 nm is a value of 3 times the thickness of the magnetic layer 3.

In Comparative Example 12-1, though the error rate slightly increased with an increase of the read/write cycle number on the magnetic tape, it became substantially constant. In Comparative Example 12-1, the hybrid carbon having a minimum conduction point particle size of 50 nm contributes to the conduction point. This minimum conduction point particle size of 50 nm is a value of 1.0 time the thickness of the magnetic layer 3.

On the other hand, in Comparative Example 12-2, though the error rate became substantially constant without recourse to the read/write cycle number on the magnetic tape, the error rate was in the order of the sixth power at a stage of the beginning of cycle and fell outside the specification of LTO. In Comparative Example 12-2, the hybrid carbon having a minimum conduction point particle size of 160 nm contributes to the conduction point. This minimum conduction point particle size of 160 nm is a value of 3.2 times the thickness of the magnetic layer 3.

Also, in Comparative Example 12-3, though the error rate became substantially constant without recourse to the read/write cycle number on the magnetic tape, the error rate was in the order of the sixth power at a stage of the beginning of cycle and fell outside the specification of LTO. In Comparative Example 12-3, the hybrid carbon having a minimum conduction point particle size of 246 nm contributes to the conduction point. This minimum conduction point particle size of 246 nm is a value of about 4.9 times the thickness of the magnetic layer 3.

From the results shown in FIGS. 21A to 22B, in a magnetic tape prepared using hybrid carbon in a wet on dry mode, it is noted that there is a tendency that when the volume proportion of silica is not more than 80%, the error rate can be decreased. Also, it is noted that there is a tendency that when the minimum conduction point particle size is not more than 250 nm (not more than 5 times the thickness of the magnetic layer 3), the error rate can be decreased.

Also, in a magnetic tape prepared using hybrid carbon in a wet on wet mode, it is noted that there is a tendency that when the volume proportion of silica is not more than 80%, the error rate can be decreased. Also, it is noted that there is a tendency that when the minimum conduction point particle size is not more than 150 nm (not more than 3 times the thickness of the magnetic layer 3), the error rate can be decreased.

While the present invention has been specifically described with reference to the embodiments thereof, it should not be construed that the present invention is limited to these embodiments, but various modifications on the basis of a technical thought of the present invention can be made therein.

For example, the configurations, the methods, the shapes, the materials and the numerical values are merely exemplification to the last, and if desired, configurations, methods, shapes, materials and numerical values different from the former may be used.

Also, the respective configurations of the foregoing embodiments can be combined with each other so far as the gist of the present invention is not deviated.

The present application contains subject matter related to those disclosed in Japanese Priority Patent Applications JP 2009-149208 and JP 2010-089054 filed in the Japan Patent Office on Jun. 23, 2009 and Apr. 7, 2010, respectively, the entire contents of which is hereby incorporated by reference.

What is claimed is:

1. A magnetic recording medium comprising:
a nonmagnetic support having both principal planes,
a nonmagnetic layer formed on one principal plane of the nonmagnetic support and containing a nonmagnetic powder, a conductive particle and a binder, and
a magnetic layer formed on the nonmagnetic layer and containing a magnetic powder, a conductive particle and a binder, wherein
each of the nonmagnetic layer and the magnetic layer is prepared in a wet on dry mode, and
a conduction point particle size of the conductive particle contained in the magnetic layer falls within the range of 3 times or more and not more than 5 times an average thickness of the magnetic layer.

2. A magnetic recording medium comprising:
a nonmagnetic support having both principal planes,
a nonmagnetic layer formed on one principal plane of the nonmagnetic support and containing a nonmagnetic powder, a conductive particle and a binder, and
a magnetic layer formed on the nonmagnetic layer and containing a magnetic powder, a conductive particle and a binder, wherein
each of the nonmagnetic layer and the magnetic layer is prepared in a wet on wet mode, and
a conduction point particle size of the conductive particle contained in the magnetic layer falls within the range of 1.3 times or more and not more than 3 times an average thickness of the magnetic layer.

3. The magnetic recording medium according to claim 1, wherein
a minimum conduction point particle size of the conductive particle contained in the magnetic layer falls within the range of 3 times or more and not more than 5 times an average thickness of the magnetic layer.

4. The magnetic recording medium according to claim 2, wherein
a minimum conduction point particle size of the conductive particle contained in the magnetic layer falls within the range of 1.3 times or more and not more than 3 times an average thickness of the magnetic layer.

5. The magnetic recording medium according to claim 1 or 2, wherein
a part of the conductive particles contributing to the conduction point is projected from both of the surface of the magnetic layer and an interface between the magnetic layer and the nonmagnetic layer.

6. The magnetic recording medium according to claim 1 or 2, wherein
the conductive particle of the magnetic layer includes
a nonconductive particle, and
a carbon particle attached to the surface of the nonconductive particle.

7. The magnetic recording medium according to claim 1 or 2, wherein
the conductive particle is a metal particle.

8. The magnetic recording medium according to claim 1 or 2, wherein
a surface electric resistance on the side of the magnetic layer-forming surface is not more than 2×10⁵ Ω/cm².

9. The magnetic recording medium according to claim 1 or 2, wherein
a thin film containing an oxide of Al or Cu is formed on the surface of the nonmagnetic support.

10. The magnetic recording medium according to claim 1 or 2, which is used in a recording and reproducing system to which a linear mode is applied.

11. A method for manufacturing a magnetic recording medium comprising the steps of:
coating a nonmagnetic layer-forming coating material on a nonmagnetic support and drying it to form a nonmagnetic layer; and
coating a magnetic layer-forming coating material on the nonmagnetic support and drying it to form a magnetic layer, wherein
a conduction point particle size of a conductive particle of the magnetic layer falls within the range of 3 times or more and not more than 5 times an average thickness of the magnetic layer.

12. A method for manufacturing a magnetic recording medium comprising the steps of:
coating a nonmagnetic layer-forming coating material and a magnetic layer-forming coating material in success on a nonmagnetic support; and
drying the nonmagnetic layer-forming coating material and the magnetic layer-forming coating material each coated on the nonmagnetic support to form a nonmagnetic layer and a magnetic layer, respectively on the nonmagnetic support, wherein
a conduction point particle size of a conductive particle of the magnetic layer falls within the range of 1.3 times or more and not more than 3 times an average thickness of the magnetic layer.

13. A magnetic recording medium comprising:
a nonmagnetic support having both principal planes,
a nonmagnetic layer formed on one principal plane of the nonmagnetic support and containing a nonmagnetic powder, a conductive particle and a binder, and
a magnetic layer formed on the nonmagnetic layer and containing a magnetic powder, a conductive particle and a binder, wherein
each of the nonmagnetic layer and the magnetic layer is prepared in a wet on dry mode,
a conduction point particle size of the conductive particle contained in the magnetic layer is not more than 5 times an average thickness of the magnetic layer, and
the number of conductive particles exposed on one principal plane of the magnetic layer is 14 or more per 100 μm².

14. A magnetic recording medium comprising:
a nonmagnetic support having both principal planes,
a nonmagnetic layer formed on one principal plane of the nonmagnetic support and containing a nonmagnetic powder, a conductive particle and a binder, and
a magnetic layer formed on the nonmagnetic layer and containing a magnetic powder, a conductive particle and a binder, wherein
each of the nonmagnetic layer and the magnetic layer is prepared in a wet on wet mode,
a conduction point particle size of the conductive particle contained in the magnetic layer is not more than 3 times an average thickness of the magnetic layer, and
the number of conductive particles exposed on one principal plane of the magnetic layer is 15 or more per 100 μm².

15. A method for manufacturing a magnetic recording medium comprising the steps of:
coating a nonmagnetic layer-forming coating material on a nonmagnetic support and drying it to form a nonmagnetic layer; and
coating a magnetic layer-forming coating material on the nonmagnetic layer and drying it to form a magnetic layer, wherein
a conduction point particle size of a conductive particle of the magnetic layer is not more than 5 times an average thickness of the magnetic layer, and
the number of conductive particles exposed on one principal plane of the magnetic layer is 14 or more per 100 μm².

16. A method for manufacturing a magnetic recording medium comprising the steps of:
coating a nonmagnetic layer-forming coating material and a magnetic layer-forming coating material in success on a nonmagnetic support; and
drying the nonmagnetic layer-forming coating material and the magnetic layer-forming coating material each coated on the nonmagnetic support to form a nonmagnetic layer and a magnetic layer, respectively on the nonmagnetic support, wherein
a conduction point particle size of a conductive particle of the magnetic layer is not more than 3 times an average thickness of the magnetic layer, and
the number of conductive particles exposed on one principal plane of the magnetic layer is 15 or more per 100 μm².
